(19) United States
(12) Patent Application Publication
(10) Pub. No.: US 2026/0181586 A1
(43) Pub. Date: Jun. 25, 2026

(54) METHODS, ARCHITECTURES, APPARATUSES AND SYSTEMS POWER CONTROL AND BEAM DETERMINATION FOR TRACKING

(71) Applicant: InterDigital Patent Holdings, Inc., Wilmington, DE (US)

(72) Inventors: Remun Koirala, London (GB); Fumihiro Hasegawa, Westmount (CA); Paul Marinier, Brossard (CA); Ghyslain Pelletier, Montreal (CA); Moon IL Lee, Melville, NY (US); Arman Shojaeifard, London (GB); Tao Deng, New York, NY (US); Kevin Wanuga, Souderton, PA (US); Kunjan Shah, London (GB)

(21) Appl. No.: 18/991,220

(22) Filed: Dec. 20, 2024

(51) Int. Cl. H04W 64/00; H04B 17/309; H04L 5/00

(52) U.S. Cl. CPC H04W 64/006; H04B 17/309; H04L 5/0048

(57) ABSTRACT

A wireless transmit/receive unit (WTRU) may determine optimal configurations for transmission power and transmission beams for tracking. In certain representative embodiments, a WTRU may receive, from a wireless network, a first configuration information. The WTRU may perform at least one sensing measurement based at least in part on the first configuration information. The WTRU may detect an occurrence of an event. The WTRU may send, based at least in part on detecting the occurrence of the event, a request to the wireless network for transmission parameters, wherein the transmission parameters are for tracking an object. The WTRU may receive, from the wireless network transmission parameters. The WTRU may transmit reference signals based at least in part on the transmission parameters for tracking the object along a tracking path.

### TECHNICAL FIELD

The present disclosure is generally directed to the fields of communications, software and encoding, including, for example, methods, architectures, apparatuses, systems related to power control and beam determination for tracking.

### SUMMARY

In accordance with certain representative embodiments of the present disclosure, methods and systems are provided for determining, by a wireless transmit/receive unit (WTRU), optimal configurations for transmission power and transmission beams for tracking. In certain representative embodiments, a WTRU may receive, from a wireless network, a first configuration information. The first configuration information may include at least one of a downlink-positioning reference signal (DL-PRS) configuration, a reference DL-PRS identification (ID), or assistance information for tracking. The WTRU may perform at least one sensing measurement based at least in part on the first configuration information. The WTRU may detect an occurrence of an event. The event may be at least one sensing measurement exceeding a threshold. The WTRU may send, based at least in part on detecting the occurrence of the event, a request to the wireless network for transmission parameters, wherein the transmission parameters are for tracking an object. Transmission parameters may include at least one of a transmission power, transmission beam, or sounding reference signal for positioning (SRSp) configuration information. The WTRU may receive, from the wireless network transmission parameters. The WTRU may transmit reference signals based at least in part on the transmission parameters for tracking the object along a tracking path.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A shows a system diagram illustrating an example communications system, according to one or more embodiments of this disclosure;

FIG. 1B shows a system diagram illustrating an example wireless transmit/receive unit (WTRU) that may be used within the communications system illustrated in FIG. 1A, according to one or more embodiments of this disclosure;

FIG. 1C shows a system diagram illustrating an example radio access network (RAN) and an example core network (CN) that may be used within the communications system illustrated in FIG. 1A, according to one or more embodiments of this disclosure;

FIG. 1D shows a system diagram illustrating a further example RAN and a further example CN that may be used within the communications system illustrated in FIG. 1A, according to one or more embodiments of this disclosure;

FIG. 2 shows a scenario of a WTRU determining path measurements based on relative delay or angle of arrival (AoA) measurements, according to one or more embodiments of this disclosure;

FIG. 3 shows a procedure for requesting and reporting capabilities for a tracking procedure, according to one or more embodiments of this disclosure;

FIG. 4 shows a scenario where a reference signal may be used as assistance information, according to one or more embodiments of this disclosure;

FIG. 5 shows a scenario where tracking area may be determined by a measured relative delay or AoA, according to one or more embodiments of this disclosure;

FIG. 6 shows a scenario of a WTRU determining a reference DL-PRS for tracking based on a reference path, according to one or more embodiments of this disclosure;

FIG. 7 shows a scenario of a WTRU determining that multiple paths exist for tracking, according to one or more embodiments of this disclosure;

FIG. 8 shows a model of time windows with associated powers, according to one or more embodiments of this disclosure;

FIG. 9 shows a scenario of a WTRU configured with a mapping table, according to one or more embodiments of this disclosure;

FIG. 10 shows a procedure for power adjustment for a WTRU, according to one or more embodiments of this disclosure;

FIG. 11 shows a scenario of a WTRU receiving a sequence of transmission powers and a sequence of transmission times, according to one or more embodiments of this disclosure;

FIG. 12 shows a procedure of a WTRU receiving a sequence of resources and performing transmissions based on the sequence, according to one or more embodiments of this disclosure; and

FIG. 13 shows a flowchart of illustrative steps for power control and beam determination for tracking, according to one or more embodiments of this disclosure.

### DETAILED DESCRIPTION OF THE DRAWINGS

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device and/or any element thereof carries out an operation, process, algorithm, function and/or any portion thereof, it is to be understood that any embodiments described and/or claimed herein assume that any apparatus, system, device and/or any element thereof is configured to carry out any operation, process, algorithm, function and/or any portion thereof.

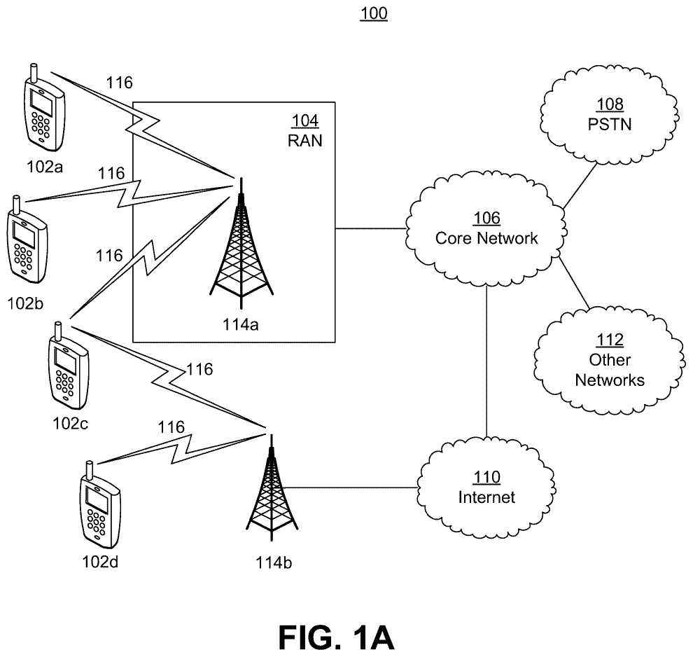

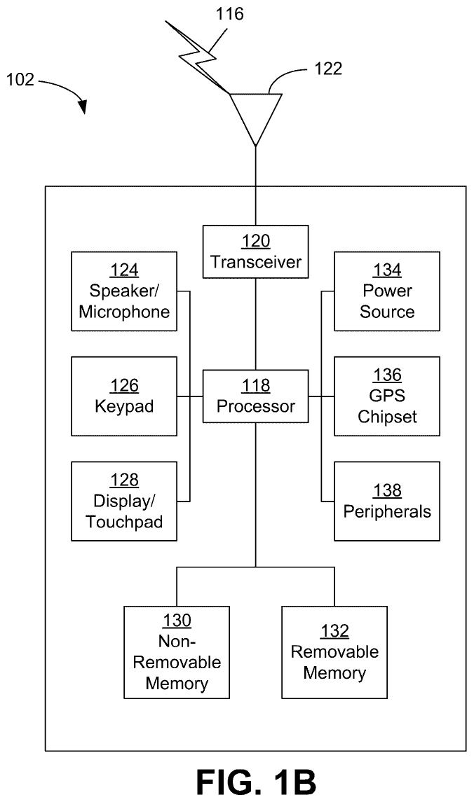

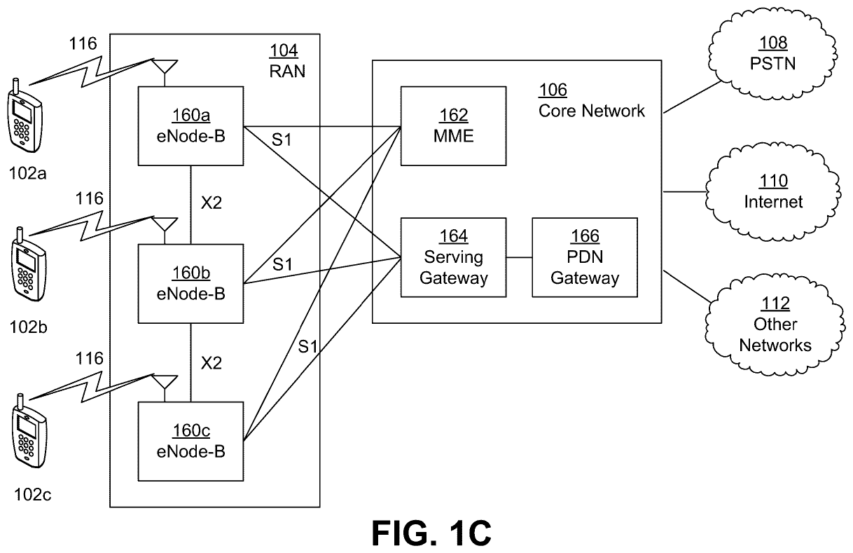

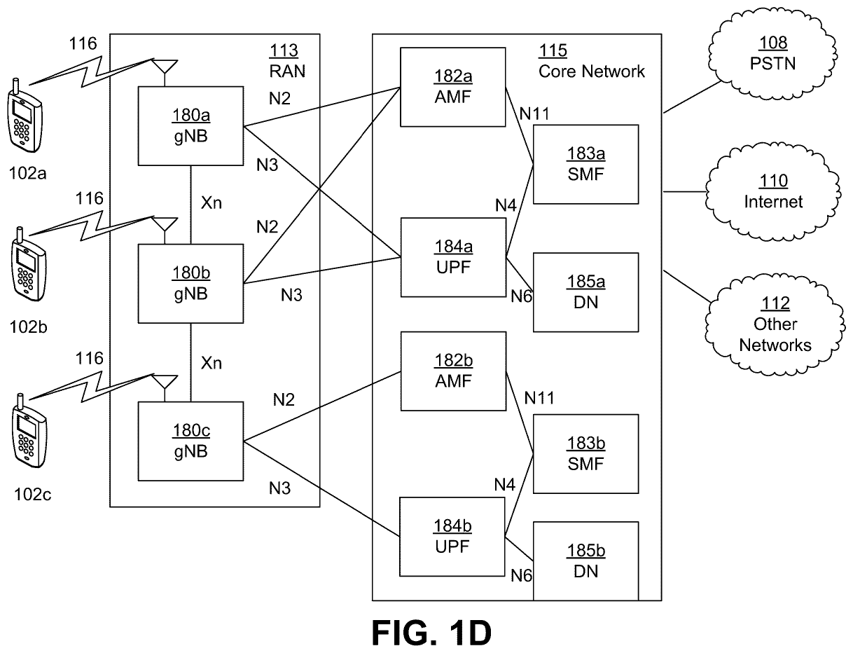

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, or broadcast to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) one or more user equipment (UE) components, a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE, and vice versa, e.g., if the WTRU includes only one active UE.

As used herein, a sensing device may refer to any device that can perform sensing based on a wireless signal, including but not limited to any of the WTRUs 102a, 102b, 102c and 102d, any UE, any base station (e.g., base station 114a of RAN 104, or base station 114b), any suitable eNode-B (e.g., any eNode-B 160a, 160b, or 160c), any suitable gNode-B (e.g., any gNode-B 180a, 180b, or 180c), any hardware of a core network (e.g., hardware configured to execute any access and mobility function (AMF), user plane function (UPF), session management function (SMF) or data network (DN) of a core network), or any other suitable device. In this disclosure, a sensing device may be interchangeably referred to as a sensor, a sensor node, or a sensing node.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), or relay nodes. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, or NR) to establish any of a small cell, picocell or femtocell. As shown in FIG. 1A, the base station 114b may have a direct connection to the Internet 110. Thus, the base station 114b need not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment. It will be appreciated that the WTRU 102 may include multiple iterations of any the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

As mentioned, although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion)), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and/or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode need not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, or entity.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards UPFs 184a, 184b, routing of control plane information towards AMFs 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one SMF 183a, 183b, and at least one DN 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The MME 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

FIG. 1E is a block diagram illustrating an example of an ISF that may be executed on processing equipment coupled to communication equipment and that may be used within the communications system illustrated in FIG. 1A according to some embodiments of this disclosure. The ISF 190 of FIG. 1E can be part of RAN 104 or 113, a part of core network 106 or 115, a part of other networks 112, or any other suitable part (e.g., node) of a wireless network. The ISF 190 can be any suitable hardware, software, or both, for implementing the functionality of the ISF 190 as described in the present disclosure. As shown, ISF 190 may include processing equipment 191 to execute the logic of ISF 190 as described in the present disclosure. For example, processing equipment 191 may determine how to reconfigure sensing devices for performing an ongoing sensing task. Communication equipment 192 may be included among the hardware that executes ISF 190 to send and receive data between ISF 190 and any other suitable sensing device (e.g., between ISF 190 and one or more of WTRUs 102a, 102b, 102c, or 102d, RAN 104, core network 106, any suitable UE, any suitable base station 114, any suitable fusion device, any other device executing a function of a wireless network, or any combination thereof). It will be understood that ISF 190 may include one or more physical hardware components that may be distributed. For example, if the ISF 190 is implemented at any one or more of the NEF, AMF, SMF, or RAN, then the hardware of ISF 190 would be the same as the hardware of the one or more of the NEF, AMF, SMF, or RAN. It will also be understood that the ISF 190 is one illustrative and non-limiting function that may be used to perform a distributed sensing task with sensing device reconfiguration.

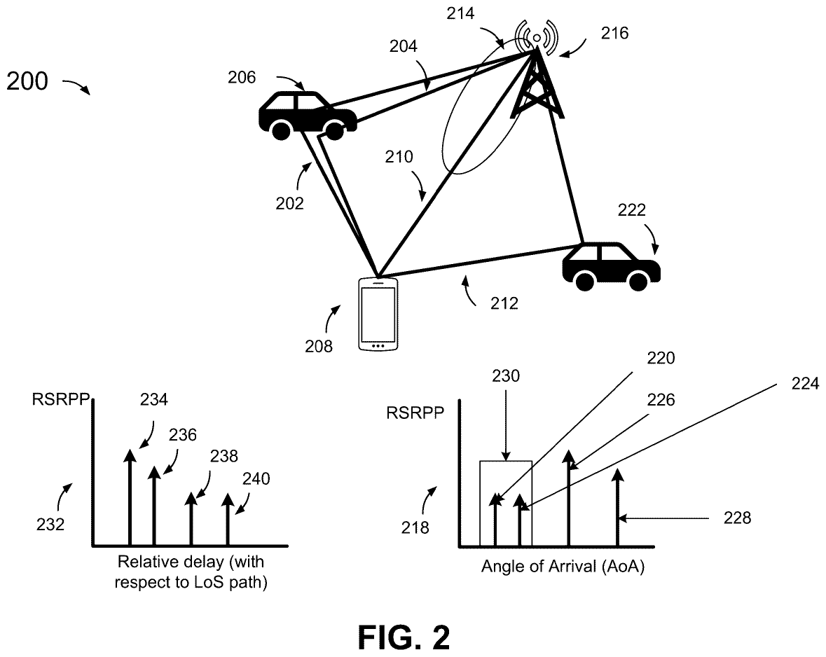

In accordance with some embodiments of this disclosure, the devices and systems of FIGS. 1A-1D may be used in connection with devices, systems, and methods for selection of a reference signal for channel impulse response estimation. For example, the devices and systems of FIGS. 1A-1D may be used in connection with the devices, systems, and methods described in FIGS. 2-13, in some embodiments of this disclosure.

In accordance with some embodiments of this disclosure, sensing hereinafter refers to the estimation of one or more spatial characteristics (e.g., the absolute or relative position, 3D orientation, speed) of one or multiple objects that are not connected to the system under consideration. In some embodiments, sensing may be considered a usage scenario (e.g., when considering integrated sensing and communications (ISAC)). In certain representative embodiments, localization relates to the estimation of one or more spatial characteristics of one or multiple devices wirelessly connected to the system under consideration such as a WTRU. It is to be understood that reference to a WTRU may include any one or more suitable WTRUs such as one or more of WTRUs 102a, 102b, 102c, 102d, 208, 304, 402, 502, 508, 602, 702, 902, 1004, 1102, or 1204 and may be used interchangeably with any of the terms UE, sensing device, or sensing receiver. It is to be understood that a sensing transmitter may be used interchangeably with any of the terms transmit receive point (TRP), base station, or gNB. It is to be understood that reference to a base station may include any one or more suitable base stations such as one or more of base stations 114a, 114b. It is to be understood that reference to a gNB may include any one or more suitable gNBs such as one or more of 180a, 180b, 180c.

Sensing may involve any one of detecting, estimating, and monitoring conditions of an environment and/or objects within an environment (e.g., shape, size, orientation, speed, location, distances or relative motion between objects) using radio frequency (RF) signals. Different sensing modes may include monostatic and bistatic sensing, depending on the transmitter and receiver location. A monostatic sensing mode may refer to an architecture including a co-located transmitter and receiver (e.g., a transmitter and receiver are at the same location). Bistatic sensing may refer to a non-co-located transmitter and receiver (e.g., a transmitter and receiver are at different locations). Likewise, multi-static sensing may refer to bistatic sensing with multiple transmitters and/or receivers.

Tracking for sensing may involve the monitoring of one or more target objects (e.g., which may be mobile or static during more than one measurement occasion). Tracking may include determining and/or monitoring the location, speed, path trajectory, direction, or any other relevant metric of the target object over time. It is to be understood that a measurement occasion is an occasion in which a measurement (e.g., associated with at least one downlink reference signal such as synchronization signal burst (SSB), channel state information reference signal (CSI-RS), DL-PRS, etc.) occurs. A measurement may refer to at least one or a combination of the following: reference signal received power (RSRP), reference signal received power per path (RSRPP), delay, relative delay, AoA, Doppler shift, delay spread, Doppler spread, reference signal time difference (RSTD), WTRU receiving-transmission time difference, reference signal carrier phase (RSCP) measurement (e.g., per path), reference signal phase difference (RSCPD) measurement (e.g., per path), or any other metric typically used to describe wireless communication systems. It is to be understood that a target object, which may otherwise also be known as an object, may refer to at least one of a sensing target, environmental object (EO), scattering point, or any elements in the channel that may cause a multipath reflection.

Sensing may be downlink or uplink, and network-based, WTRU-assisted, or WTRU-based. Sensing may differ based on the role of each node in the sensing infrastructure such as a TRP, UE, CN, sensing management function (SMF), location management function (LMF), or other higher layer entities including other applications. Sensing information may be a measurement, location information for a target object or target objects, velocity information of the target object or target objects, or any other relevant data. It is to be understood that tracking and sensing may be used interchangeably. In this disclosure, tracking may refer to at least one or a combination of procedures related to sensing (e.g., uplink, downlink, detection, monitoring, monostatic, bistatic, etc.).

Power control may be an issue in NR for both DL and UL transmissions as a mechanism for improving at least one of system capacity, coverage, or QoS while limiting interference to neighbor cells. Power control for a UL channel may include components such as maximum transmit power, gNB's target received power, pathloss compensation factor, modulation coding scheme (MCS) factors, resource block (RB) factors, or the closed loop power control command to be indicated by the gNB.

In some implementations, UL power control for positioning may be defined in sounding reference signal for positioning (SRSp) resources. SRSp resources for UL power control may differ from SRSp resources for positioning because UL power control architecture may require multiple TRPs for accurate positioning. As a result, transmit power may need to be determined with respect to multiple TRPs. A pathloss compensation factor may be dependent on the locations of the serving and neighboring TRPs.

In addition to power control, transmit beam selection may be another aspect for positioning. For a WTRU with beamforming capabilities, optimal beam selection allows the WTRU to direct its power to the gNBs. This may improve the received signal-to-noise ratio (SNR) of the SRSp resources improving the accuracy of positioning as well as reducing interference to other gNB(s) and/or WTRUs.

In some implementations, the procedure for transmit beam selection for uplink SRSp resources includes the network configuring the WTRU with a higher layer parameter (e.g., spatialrelationInfoPos) consisting of an index of a downlink reference RS. The WTRU, upon receiving the reference RS, determines the transmit beam direction as the receive filter used for reception the RS. In case the WTRU is not configured with the parameter, or the WTRU does not receive the indicated reference RS, the WTRU may determine the transmit direction as a fixed or a different spatial domain transmit filter.

A semi-statically configured SRSp configuration may not be optimal for tracking a mobile object. To determine the optimal transmission power and transmission beam, the WTRU may require information including at least one of object location, trajectory, velocity, or any other relevant piece of information. A WTRU may hence require a dynamic knowledge of the object from the gNB for tracking purposes.

In some implementations, NR may not have any special functionalities or support dedicated to sensing. However, NR may have various features defined for positioning including DL/UL reference signals, architecture, or protocols. Sensing features may be developed based on the NR positioning features.

Uplink SRSp power control for uplink positioning may be specified where the power is a function of the measured path loss between the WTRU and a TRP. The TRPs may be associated with the serving cell or neighboring cell.

SRSp beam direction may be based on a receiving filter used to receive a reference DL-RS (e.g., synchronization signal burst (SSB), channel state information reference signal (CSI-RS), DL-PRS) or based on a fixed or a configured order (e.g., beam sweeping).

In certain representative embodiments, a WTRU may, from a network, receive a sequence of SRSp transmission timings (e.g., relative timing T1, T2) and corresponding SRSp transmission parameters for tracking a path from the network based on certain trigger conditions.

In certain representative embodiments, a WTRU may receive, from a network, a periodic DL-PRS configuration, a reference DL-PRS identification (ID), and an indication of a tracking path timing (e.g., relative timing with respect to a first path) to track. A WTRU may periodically perform at least one measurement on the reference DL-PRS ID and determine a tracking path based on the indicated tracking path timing. If the change in measurements (e.g., RSRPP) for the tracking path is above a threshold, the WTRU may report the measurements to the network and request for SRSp transmission parameters (e.g., transmission power and transmission beam parameters) from the network. A WTRU may receive (e.g., via medium access control-control element (MAC-CE)) a sequence of relative SRSp transmission timings (e.g., timings with respect to the MAC-CE command reception) and the corresponding SRSp transmission parameters per SRSp transmission timing for tracking the determined path.

A WTRU may hence be enabled to dynamically receive and/or determine SRSp transmission configurations during uplink sensing or an uplink tracking procedure. A WTRU may hence be enabled to determine optimal SRSp configurations for tracking to sense a target object with the required QoS requirements (e.g., accuracy, latency, or any other QoS requirement).

It is to be understood that reference to a TRP may be used interchangeably with any one of the terms gNB, positioning reference unit (PRU), sensing transmitter, UE, or WTRU. The term TRP may reference an entity (e.g., RAN entity) capable of transmitting a reference signal (e.g., DL-PRS, SSB, CSI-RS). Reference to a TRP may include any one or more suitable TRPs such as one or more of TRPs 216, 408, 516, 518, 608, 718, or 1104.

It is to be understood that reference to WTRU may be used interchangeably with any one of the terms sensing receiver or UE. Reference to a WTRU may include any one or more suitable WTRUs such as one or more of WTRUs 102a, 102b, 102c, 102d, 208, 304, 402, 502, 508, 602, 702, 902, 1004, 1102, or 1204. A WTRU may reference an entity (e.g., RAN entity) capable of receiving and measuring a reference signal (e.g., DL-PRS, SSB, CSI-RS).

It is to be understood that reference to a wireless network, which may also be referred to simply as a network, may refer to the access mobility function (AMF), LMF, gNB, NG RAN, TRP, or any other entity involved in sensing functionalities (e.g., SMF). It is to be understood that reference to an LMF is a non-limiting example of a node or entity (e.g., network node or entity) that may be used for or to support positioning and/or sensing. Any other node or entity (e.g., server UE, SMF) may be substituted for an LMF and still be consistent with this disclosure.

It is to be understood that reference to an RS may refer to any of the positioning and reference signals (e.g., DL-PRS, SRSp, CSI-RS, demodulation reference signal (DM-RS), or SSB).

It is to be understood that reference to a DL-PRS may refer to any of the downlink positioning or any other reference signals that may be received and/or measured by the WTRU (e.g., SSB, CSI-RS).

It is to be understood that reference to a location may be used interchangeably with the term position. A location (e.g., UE location, TRP location) may be expressed in terms of altitude, latitude, geographic coordinate, or local coordinate. It is to be understood that reference to an ID may be used interchangeably with the term index and that reference to a path may be used interchangeably with the term multipath.

It is to be understood that a tracking area may be defined as a region, coarse location, zone ID, or any other representation of a geographical area (e.g., a set of points such as a convex hull around a point or a location representing center of a shape such as a rectangle with associated parameters). A tracking area may also specify a region of uncertainty. It is to be understood that reference to a coarse location may be defined by ellipsoid point (e.g., defined by latitude degree, longitude degree and/or latitude sign) or a geographical location (e.g., 2D location, 3D location). A coarse location may consist additionally of an uncertainty region (e.g., circle, sphere, ellipse, ellipsoid, or any other suitable shape). It is to be understood that a zone ID may be defined with reference to a geographical reference (e.g., (0, 0)) and may refer to a geographical area (e.g., square area of zone length L) defined by a point and the length of the square. In an example, for a given zone length L (e.g., configured by the network), a WTRU may be able to determine the area based on the ID based on a mathematical mapping equation or a table.

It is to be understood that angle units may be in terms of at least one of degrees, radians, or any other suitable angle measurement unit. It is to be understood that frequency range units may be in terms of at least one of hertz (Hz), number of resource elements (REs), number of resource blocks (RBs), bandwidth part (BWP), or power frequency level (PFL). It is to be understood that frequency index units may be in terms of at least one of Hz, RE index, RB index, PFL ID, or BWP ID.

In certain representative embodiments, a WTRU may receive at least one of configurations (e.g., RS configurations, measurement configurations, reporting configurations), indications (e.g., power indication, beam indication, configuration, activation, deactivation, switching command), or preconfigured thresholds from the network (e.g., LMF, gNB) via downlink physical channel (e.g., PDSCH, PDCCH) or via lower or higher layer signaling (e.g., downlink control information (DCI), MAC-CE, radio resource control (RRC) or LTE positioning protocol (LPP) message). A WTRU may send the measurement report (e.g., containing the measurements) or indications (e.g., request) to the network (e.g., LMF, gNB) via a semi-static (e.g., LPP, RRC) or dynamic message (e.g., uplink control indicator (UCI), MAC-CE) or via uplink channel (e.g., PUCCH, PUSCH).

In certain representative embodiments, a WTRU may send a measurement report (e.g., containing the measurements), indications (e.g., request), other relevant information to the network (e.g., LMF, gNB) via a semi-static (e.g., LPP, RRC) or dynamic message (e.g., UCI, MAC-CE) or via uplink channel (e.g., PUCCH, PUSCH). In an example, a WTRU may indicate an RS resource index, RS index or RS ID associated with measurements in the measurement report to indicate which RSs the WTRU measured to derive the measurements (e.g., RSRPP, AoA). A WTRU may include a TRP ID or index in the measurement report to indicate which TRP's DL-PRSs the WTRU made measurements on.

It is to be understood that reference to a RSRPP (or RSRP) threshold may be defined with respect to first path RSRPP (or RSRP). In an example, a threshold may be −3 dB, so the threshold may be of 3 dB lower than that of first path. It is to be understood that dependency of a first parameter with a second parameter may be interpreted as the first parameter being a first value, if the second parameter is above a threshold, and a second value otherwise.

In certain representative embodiments, a PRS configuration may include at least one of a variety of parameters. In an example, a parameter may be at least one of a number of symbols, transmission power, number of PRS resources included in PRS resource set, muting pattern for PRS (e.g., the muting pattern may be expressed via a bitmap), periodicity, type of PRS (e.g., periodic, semi-persistent, or aperiodic), slot offset for periodic transmission for PRS, or vertical shift of PRS pattern in the frequency domain. In an example, a parameter may be at least one of a time gap during repetition, repetition factor, RE offset, comb pattern, comb size, spatial relation, quasi co-location (QCL) information (e.g., QCL target, QCL source) for PRS, number of PRUS, or number of TRPs. In an example, a parameter may be at least one of a absolute radio-frequency channel number (ARFCN), subcarrier spacing, expected RSTD, uncertainty in expected RSTD, start physical resource block (PRB), bandwidth, bandwidth part (BWP) ID, number of frequency layers, start/end time for PRS transmission, on/off indicator for PRS, TRP ID, PRS ID, cell ID, global cell ID, PRU ID, or applicable time window. A WTRU may apply a PRS configuration under a condition that the current time is within the applicable time window. A WTRU may receive beam width of a PRS or boresight direction (e.g., angle of departure (AoD)) of PRS from the network. The configuration described herein is not limited to PRS and may be applicable to any DL-RS.

In certain representative embodiments, an SRSp or SRS configuration may include at least one of variety of parameters. In in example, a parameter may include at least one of a resource ID, comb offset values, or shift values. In an example, a parameter may include at least one of a start position in the frequency domain, number of SRSp symbols, shift in the frequency domain for SRSp, frequency hopping pattern, type of SRSp (e.g., aperiodic, semi-persistent or periodic), sequence ID used to generate SRSp, or other IDs used to generate SRSp sequence. In an example, a parameter may include at least one of a spatial relation information indicating which reference signal (e.g., DL-RS, UL-RS, CSI-RS, SRS, DM-RS) or SSB (e.g., SSB ID, cell ID of the SSB) the SRSp is related to spatially where the SRSp and DL-RS may be aligned spatially. In an example, a parameter may include at least one of a QCL information (e.g., a QCL relationship between SRSp and other reference signals or SSB), QCL type (e.g., QCL type A, QCL type B, QCL type D), resource set ID, list of SRSp resources in the resource set, transmission power related information, bandwidth (e.g., expressed in terms of MHz, number of RBs) or frequency information (e.g., center frequency, ARFCN, frequency layer ID, component carrier ID). In an example, a parameter may include at least one of a pathloss reference information which may contain index for SSB, CSI-RS or PRS, periodicity of SRSp transmission, spatial information such as spatial direction information of SRSp transmission (e.g., beam information, angles of transmission), spatial direction information of DL-RS reception (e.g., beam ID used to receive DL-RS, angle of arrival).

In certain representative embodiments, an RSRPP (e.g., in terms of dBm, dBW) may be referred to as the path-wise power measurement that may be associated with a path. A path may be characterized by an i-th measurement component (e.g., i-th delay component, i-th angle of arrival (AoA) component) of the resource elements that carry DL-RS signal(s). In an example, the RSRPP associated with the first path measurement (e.g., 1-st delay component, 1-st AoA component) may correspond to the power contribution associated with the first detected path in time.

In certain representative embodiments, the AoA (e.g., measured in degrees or radians) may be defined as the azimuth and/or the vertical angle with which the WTRU receives the transmitted RS with respect to a reference direction. A reference direction may either be defined in the global coordinate system (e.g., geographical north) or in the local coordinate system (e.g., orientation of the WTRU measured in terms of Euler angles (e.g., degrees, radians)). In an example, the WTRU may measure the AoA per path associated with the received DL-RS. The WTRU may determine the AoA based on an algorithm (e.g., subspace-based algorithms such as MUltiple SIgnal Classification (MUSIC)/Estimation of Signal Parameters via Rotational Invariant Technique (ESPIRIT)) or based on the angles of the receiving beam used to receive the RS (e.g., angle associated with the receiving filter) if the WTRU is able to perform receiving beamforming, based on WTRU capability. The resolution of the measured AoA may depend on the number of antenna elements, the antenna pattern at the WTRU, the granularity of receiving beams by the WTRU, any other relevant component, or any other suitable combination thereof.

In certain representative embodiments, a relative delay (e.g., measured in terms of number of symbols, slots, frames, subframes, or seconds) measurement of a path (e.g., i-th path) may be referred to as the time duration associated with the delay component (e.g., i-th delay component) of the resource elements that carry received DL-RS with respect to the reference delay component (e.g., 1-st delay component of the DL-RS). Measuring the excess delays may be dependent on the time measurement resolution capability of the WTRU. A WTRU's capabilities may depend on a signal bandwidth for sensing. Resolution may also depend on the ability of the WTRU to process (e.g., compute fast Fourier transform (FFT)) large frequency domain samples.

In certain representative embodiments, a WTRU may receive a (e.g., configured) DL-PRS resource through multipath reflections. A WTRU may hence receive one or more copies of the resource with different characteristics and measurements depending on the channel conditions.

In certain representative embodiments, a path may be characterized by at least one of one or more RSRPP measurements, one or more AoA (e.g., per path) measurements, one or more relative delay measurements, one or more delay spread measurements, one or more carrier-phase (e.g. per path) measurements, one or more doppler shift (e.g., per path) measurements, or one or more doppler spread measurements. In an example, a WTRU may determine a multipath component may be determined as a path based on a variety of conditions. In an example, a condition may be that at least one of the measurements (e.g., RSRPP, doppler shift), at the least one of the statistics (e.g., variance), or the difference between at least one of the measurements between (e.g., consecutive) two measurement occasions corresponding to the multipath component is above or below a preconfigured or configured threshold.

In certain representative embodiments, two multipath components (e.g., corresponding to two distinct measurements) may be considered as the same path based on at least one of a difference between at least one of the two measurements (e.g., AoA, relative delay) being below a threshold or that each measurement satisfies at a condition for determination of a path. In an example, if the WTRU associates more than one multipath component with one path, the WTRU may characterize the path based on at least one of a statistic (e.g., average, median, mode) of the measurements associated with the multipath components, at least one of the measurements associated with the multipath components, or a multipath component with at least one of the associated measurements above a threshold.

FIG. 2 shows scenario 200 of a WTRU determining path measurements based on relative delay or AoA measurements, according to one or more embodiments of this disclosure. In scenario 200, path 202 and path 204 are associated with object 206, and path 212 is associated with object 222. WTRU 208 may determine that paths 202 and 206 are associated with each other based on a difference between the AoA or relative delay with respect to LoS path 210 exceeding a threshold. In scenario 200, WTRU 208 may receive DL-PRS 214 on LoS path 210 from TRP 216. WTRU 208 may determine that the average of the relative delay or average of the AoA may represent a path. WTRU 208 may determine that only the measured multipath components with RSRPPs above a threshold may be considered as paths.

RSRPP versus AoA graph 218 shows measured RSRPP 220 for path 202, RSRPP 224 for path 204, RSRPP 226 for LoS path 210, and RSRPP 228 for path 212. RSRPP graph 218 shows that a path for object 206 may be represented as multipath component 230 based on a difference in measurement.

RSRPP versus respective delay graph 232 shows measures RSRPP 234 for LoS path 210, RSRPP 236 for path 212, RSRPP 238 for path 202, and RSRPP 240 for path 204.

In certain representative embodiments, a WTRU may be configured to report at least one path ID associated with the path, at least one object ID associated with the path, at least one measurement (e.g., path measurement such as RSRPP, AoA, doppler spread) associated with the path, at least one statistic (e.g., variance) associated with the path measurement, at least one DL-PRS resource ID, DL-PRS resource set ID or DL-PRS beam IDs (e.g., associated with the path measurement), or measurement timestamp (e.g., in terms of time index units). It is to be understood that reference to time index units may be in terms of at least one of an absolute time (e.g., in terms of a symbol index, slot index, frame index, or subframe index) or a relative time (e.g., in terms of a number of symbols, number of slots, number of frames, or number of subframes with respect to a reference time). A measurement time stamp may be a channel impulse response (CIR). A channel impulse response, consisting of N paths, may be defined by the equation

$$h ( t ) = {\sum }_{k = 1}^{N} {h}_{k} ( t ) δ ( t - {τ}_{k} )$$

where hₖ(t) and τₖ are time-varying complex valued coefficient (e.g., expressed by a+bj where j=\sqrt{−1} for the channel impulse response and delay, measured in seconds, for the k^{th} path, respectively). The delta function may be defined as δ(t)=1 for t=0 and δ(t)=0 for t≠0. A measurement for a CIR may assume that coefficients of a defining equation may be constant such that hₖ(t)=hₖ. In an example, the WTRU may report hₖ and τₖ for each path k to the network. In an example, the WTRU may report the number of paths, N, to the network. Alternatively, the WTRU may receive hₖ and τₖ for each path k from the network and/or the number of paths.

In certain representative embodiments, a WTRU may obtain CIR measurements from the network. The network may indicate DL-RS configurations such as DL-RS resource IDs associated with the CIR. In an example, the CIR may be associated with DL-RS resource ID. A WTRU may determine that the CIR is derived based on the measurements made on the DL-RS resource associated with the ID. A WTRU may also determine that the channel along the direction of transmission of the DL-RS or reception of the DL-RS corresponds to the CIR. In an example, a CIR may be associated with a TRP ID. A WTRU may determine that the CIR represents the channel between the associated TRP and WTRU. The CIR may be associated with more than one TRPs where the network may include TRP indices associated with the CIR. A CIR may also be associated with a cell. A WTRU may receive cell ID or index associated with the CIR from the network.

In an example, a CIR may be associated with more than one TRPs or DL-RS resource IDs. A WTRU may determine that the channel between the TRPs and the WTRU corresponds to the CIR. A WTRU may also determine that the channel along the transmission directions of DL-RSs associated with IDs or reception directions of the DL-RS correspond to the CIR. In an example, more than one CIRs may be associated with one parameter from DL-RS configurations (e.g., TRP ID, DL-RS resource ID, frequency layer ID). A WTRU may receive information related to two CIRs associated with a TRP from the network

$$( e . g . , {h}_{1} ( t ) = {\sum }_{k = 1}^{{N}_{1}} {h}_{1 , k} ( t ) δ ( t - {τ}_{1 , k} ) and {h}_{2} ( t ) = {\sum }_{k = 1}^{{N}_{2}} {h}_{2 , k} ( t ) δ ( t - {τ}_{2 , k} ) )$$

from the network. A WTRU may also report information related to more than one CIRs associated with DL-RS configuration (e.g., TRP ID, DL-RS resource ID) based on the measurements to the network. There can be more than one CIRs associated with DL-RS configuration since the WTRU or network may observe different channel characteristics based on AoA of DL-RS or UL-RS. A CIR may be represented by delay profile (DP) or power delay profile (PDP). A PDP may refer to a set of delays and power profiles, such as [τ₀, τ₁, . . . , τ_{N-1}] and [p₀, p₁, . . . , p_{N-1}], where pₖ may corresponds to relative power at the k^{th} path compared to the first path. A DP may refer to a set of delays [τ₀, τ₁, . . . , τ_{N-1}] which indicates path delay for each path above p_{threshold}. The WTRU may receive p_{threshold} from the network to derive DP from PDP.

In certain representative embodiments, the WTRU may receive an indication from the network on how to generate CIR, PDP or DP based on timing, phase, or power measurements. In an example, a WTRU may send a request to the network to receive an indication on which methodologies to use to generate CIR, PDP or DP based on the measurements the WTRU made. A WTRU may receive a message from the network (e.g., via LPP, RRC, MAC-CE, DCI) indicating the DL-RS resource indices and associated measurement types (e.g., RSTD, AoA) to use to generate at least one of CIR, PDP or DP. In an example, a WTRU may receive an indication from the network indicating to generate at least one of CIR, PDP or DP.

In certain representative embodiments, a WTRU may receive a threshold (e.g., power threshold) from the network and timing range (e.g., 0 μs to 1 μs), timing granularity (e.g., every 0.1 μs in the indicated timing range, 100 sample points in the indicated timing range) of at least one of CIR, PDP or DP. A WTRU may determine to report power and timing (e.g., relative timing compared to a reference timing, absolute timing) of any samples whose received power is over the threshold. In an example, the CIR the WTRU reports to the network may be defined by a configured number of samples (e.g., N) where the WTRU is configured with granularity of samples (e.g., a certain number of seconds apart). The number of samples may be defined within a window. A WTRU may report samples whose RSRP is over the configured threshold or some number of highest RSRP among the samples. A WTRU may indicate locations or sample indices of samples where the WTRU measures some number of the highest RSRP samples. The first sample may be defined as the earliest arriving path (e.g., first path). Samples may be defined with respect to a reference timing (e.g., time of arrival (ToA) of reference or indicated DL-RS, ToA of the earliest arriving DL-RS). A WTRU may report timing, phase, or power information per sample. The determined reference timing or first path may be rounded up or down to the defined timing granularity. The CIR, PDP or DP may refer to the impulse response between WTRU and TRP or associated with a DL-RS (e.g., DL-RS resource ID) or DL-RS resources (e.g., DL-RS resource IDs).

In an example, a WTRU may report the ToA of DL-RS corresponding to the reflected signal. When the WTRU indicates, in the report sent to the network, the ToA of DL-RS corresponding to the reflected signal against the target, the WTRU may indicate the relative timing with respect to the reference timing (e.g., first sample or ToA of the reference RS, ToA corresponding to the LoS). The WTRU may report, to the network, determined the reference timing (e.g., based on the RS configured by the network, first sample within the window). In an example, a WTRU may report AoA for samples whose RSRP is over the configured threshold. A WTRU may report AoA for a certain number of samples with a certain number of highest RSRPs within the window.

In an example, a WTRU may receive a relative timing information from the network, with respect to a reference timing. The relative timing information is associated with an DL-RS indicated by the network. The relative timing information may correspond to the relative ToA of reflected DL-RS against the target where relative ToA is defined with respect to the reference timing. The relative timing information sent from the network may be used by the WTRU to estimate the location of the target or to determine ToA of the associated DL-RS. The relative timing information may be associated with an expected AoA (e.g., reception angle from which the UE receives the DL-RS) or angle of departure (AoD) from which the DL-RS is transmitted,

In certain representative embodiments, a WTRU may send measurements in a report to the network (e.g., LMF, gNB) via a semi-static (e.g., LPP, RRC) or dynamic message (e.g., UCI, UL MAC-CE). It is to be understood that DL-RS (e.g., CSI-RS, DM-RS, TRS) and SSB may be used interchangeably.

In certain representative embodiments, a WTRU may receive at least one DL-PRS configuration from the network (e.g., LMF, gNB, or any entity that configures reference signals to the WTRU) in a downlink physical channel (e.g., PDSCH or PDCCH, via higher layer signaling such as MAC-CE, RRC, DCI, or via LPP messages).

In certain representative embodiments, a WTRU may be configured to or may determine to report its tracking capability to the network. In an example, a WTRU's tracking capability may include the capability to perform, process, or report (e.g., to the network) measurements (e.g, per path measurements). In an example, a WTRU's tracking capability may include range measurement capabilities (e.g., distances where the WTRU may be able to detect, track, or monitor an object) in terms of time duration units and or distance units (e.g., as a minimum or maximum). It is to be understood that reference to time duration units may be in terms of at least one of the following: seconds, number of slots, number of symbols, number of frames, number of sub-frames, or any other duration related unit. It is to be understood that distance units may be in terms of meters, kilometers, or any other suitable distance measurement unit. In an example, a WTRU's tracking capability may include tracking angle range measurement capabilities (e.g., an angle or range of angles where the WTRU may be able to detect, track, or monitor an object). In an example, a WTRU's tracking capability may include at least one of a Doppler shift measurement capability, capability to determine its own location, velocity, or orientation, number of paths able to be processed, number of objects to be able to be processed, or the duration a WTRU may track an object for.

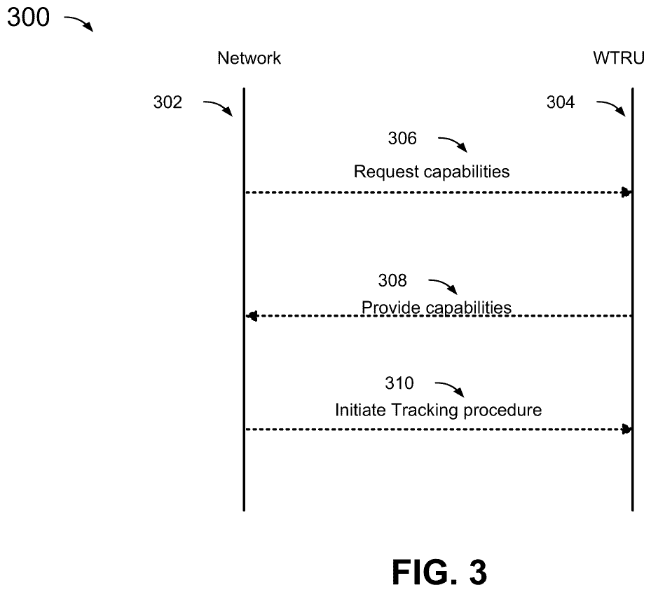

FIG. 3 shows procedure 300 for requesting and reporting capabilities for a tracking procedure, according to one or more embodiments of this disclosure. At operation 306, network 302 may request capabilities from WTRU 304. At operation 308, WTRU 304 may transmit its tracking capabilities to network 302. At operation 310, network 302 may initiate a tracking procedure for WTRU 304.

In certain representative embodiments, a WTRU may be configured to perform tracking of an object. A WTRU may determine to request configurations for tracking an object based on at least one of a variety of conditions. In an example, a condition may be that the WTRU receives an indication (e.g., DCI, MAC-CE) to activate at least one configuration associated with the tracking, a configuration (e.g., DL-PRS, measurement, reporting, SRSp) associated with tracking, an activation indication of a time window or any configuration associated with tracking, or any other relevant indication. In an example, a condition may be that the WTRU determines that a measurement (e.g., downlink path measurements) satisfies certain conditions for requesting tracking configuration such as at least one measurement being above or below a threshold, a difference between at least one measurement between two measurement conditions being above a threshold, or any other relevant condition. In an example, a condition may be that the WTRU is located within a configured reference location (e.g., coarse location, zone ID) or that the WTRU is located outside of a configured reference location. In an example, the condition may be that an error in location or error in velocity of the WTRU is above or below a configured threshold. In an example, condition may be that the velocity of the WTRU is above or below a configured threshold. If one or more conditions is not met, a WTRU may determine to terminate a tracking procedure.

In certain representative embodiments, a WTRU may be configured with a time window for a tracking procedure. A time window may be characterized by a variety of parameters. In an example, a parameter may be at least one of a time window ID, start or end time (e.g., expressed in the terms of a time index unit), a reference time index (e.g., expressed as an SFN0 time, a time instance when a WTRU receives at least one indication to initiate tracking or perform an action from a network, a measurement reporting time instance, or another relevant time instance), a duration, an offset, a periodicity, or a window type (e.g., transmission window, measurement window, or any other type of window). A WTRU may receive an activation for a time window (e.g., with a time window ID or any other relevant parameter). A tracking time window may be a window for measurement of a DL-RS or for a transmission of a UL-RS. In an example, a WTRU may receive an indication of the time window type such as if the window is for measurement or for transmission. A WTRU may only perform measurements in the measurement window or only transmission (e.g., SRSp transmission) in the transmission window.

In certain representative embodiments, a WTRU may receive an indication of a tracking range to indicate the region (e.g., geographic region, measurement region, etc.) in which the WTRU may track an object as information for a downlink measurement.

In an example, an indication of a tracking range may be a reference path ID such that the WTRU may be configured to perform tracking on an indicated path ID. A path ID may refer to any identifier or identification of paths which the WTRU may measure. A WTRU may receive multiple path IDs for tracking.

In an example, an indication of a tracking range may be a reference DL-PRS resource ID, reference DL-PRS beam ID, DL-PRS resource set ID, or reference TRP. A WTRU may receive the tracking range indication based on at least one of an indicated PRS resource, reference beam, reference resource set, or reference TRP. A WTRU may perform tracking based on measurements on the indicated resource or beams from the indicated TRP. A WTRU may consider at least one of the measurements performed as a sensing measurement or reference measurement for sensing purposes. In an example, an indication of a tracking range may be a measurement range indication. A WTRU may receive an indication of a range of measurements (e.g., minimum and/or maximum measurement thresholds for RSRP, RSRPP, AoA, relative delay, doppler shift, or phase) such that the WTRU may perform or report on tracking measurements. A WTRU may receive an indication of minimum and maximum relative delay range (e.g., with respect to a reference path, LoS path, or any other relevant path), and the WTRU may perform tracking measurements only within an indicated delay range. For example, a WTRU may receive an indication of the minimum and maximum measurement ranges with respect to an LoS path.

In certain representative embodiments, a WTRU may determine the minimum or maximum tracking area as an ellipse with foci as WTRU location and the TRP location. The ellipse may have the major axis as the sum of distance between the WTRU and TRP locations such that the distance is equivalent to the indicated minimum or maximum relative delay respectively. A WTRU may receive the relative delay indication in terms of at least one of the time duration units. A WTRU may receive an indication of the minimum or maximum AoA range. An AoA range may be with respect to a reference direction such as an absolute reference direction (e.g., global coordinate system (GCS), or true north) or relative reference direction (e.g., local coordinate system (LCS)). A WTRU may perform tracking measurements only within the given AoA range. In an example, an indication of a tracking range may be a reference associated with a downlink measurement. A WTRU may receive at least one of a reference for timing-based measurements (e.g., at least one of the SFN0 time, or relative time such as PRS transmission time, time of reception of n-th path, LoS path), a reference for angle range indications (e.g., based on an absolute direction or relative direction), or a reference path (e.g., for a given measurement occasion). A reference may be indicated for one or more measurements, independently, or together. A reference for relative phase measurement and relative delay measurement may correspond to the phase and delay of the same path.

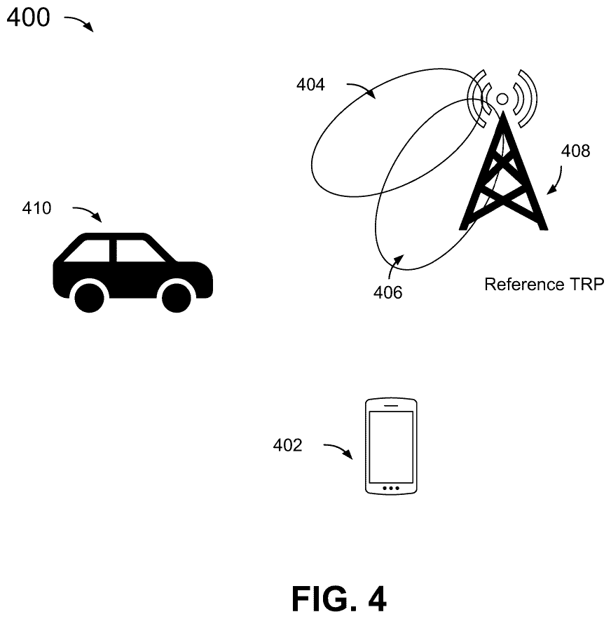

FIG. 4 shows scenario 400 where a reference signal may be used as assistance information, according to one or more embodiments of this disclosure. In scenario 400, WTRU 402 may receive an indication of DL-PRS resources such as DL-PRS 404 or DL-PRS 406 as assistance information from reference TRP 408 for tracking object 410.

In certain representative embodiments, a WTRU may receive assistance information for uplink transmission for tracking. A WTRU may receive an indication of a tracking region where the WTRU may perform uplink transmission for tracking an object. A WTRU may receive an indication of spatial direction based on at least one of a reference DL-PRS resource ID, reference DL-PRS beam ID, reference DL-PRS resource set ID, TRP ID, area indication (e.g., in terms of coarse area, zone ID), reference measurement range (e.g., relative delay range, AoA range), reference path ID, or reference locations. A WTRU may determine spatial information based at least in part on at least one of the received indications of spatial direction. A TRP, resource, beam, or resource set may indicate the sensing range or direction that a WTRU may be able to measure. A WTRU may determine to perform sensing in the indicated area based on the references. In an example, a WTRU may determine the sensing coverage area based on the location of the reference TRP, transmitted reference beam of the DL-PRS, and the WTRU location.

In certain representative embodiments, a WTRU may be configured with an association between the SRSp resources and the DL-PRS resource. In an example, the association may be a spatial relationship or a QCL (e.g., type D) association. A WTRU may determine the transmission direction of the SRSp resources based on the spatial direction of transmission or reception of at least one of the paths of the DL-PRS resource. In an example, a WTRU may determine that it may track an object in areas which correspond to the spatial direction of reception of reference DL-PRS resource ID. A WTRU may only perform tracking in the spatial direction that is based on reference measurement range such as relative delay range or an AoA range.

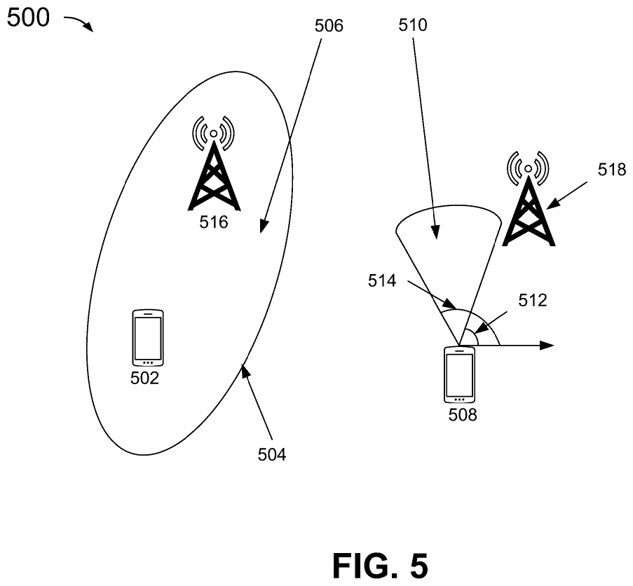

FIG. 5 shows scenario 500 where tracking area may be determined by relative delay or AoA, according to one or more embodiments of this disclosure. WTRU 502 may receive an indication of maximum relative delay indication 504 and determine tracking area 506 based on the respective maximum relative delay indication 504. WTRU 508 may determine tracking area 510 based on minimum AoA indication 512 or maximum AoA indication 514. WTRU 502 may determine tracking area 506 based on the location for WTRU 502 and/or the location of TRP 516. Similarly, WTRU 508 may determine tracking area 510 based on the location for WTRU 508 and/or the location of TRP 518.

In certain representative embodiments, an indicated tracking area may also represent a restricted tracking area where a WTRU may not perform a tracking procedure. A WTRU may determine the spatial information similarly to as described for tracking area and the WTRU may determine the spatial transmission direction of SRSp resources for uplink tracking based on the indicated restricted area.

In certain representative embodiments, a WTRU may receive an indication of the object information including at least one of an object location, object velocity, object trajectory, object radar cross section, object type (e.g., UAV, vehicle, human), object material (e.g., steel, plastic), SRSp resource ID, SRSp resource set ID, SRSp beam ID, or a timestamp of object information. In an example, a WTRU may receive an indication of the SRSp resource that the network used to determine the object information. A WTRU may determine a SRSp configuration for sensing based on the indicated information with regards to the tracking object.

In certain representative embodiments, a WTRU may receive an indication of an association of configuration between at least one of an SRSp resource configuration or associated assistance information, DL-PRS configuration or associated assistance information, time window, or path ID. In an example, due the time dependent nature of tracking such that the object or the path a WTRU may be configured to perform tracking on may change dynamically, the WTRU may receive an activation indication of an associated configuration. Activation of a configuration may be an implicit indication to the WTRU to activate at least one of the associated configurations. A WTRU may receive an activation or deactivation indication for an associated configuration in a downlink physical channel (e.g., PDSCH or PDCCH, via higher layer signaling such as MAC-CE, RRC, DCI or via LPP messages) from the network.

In certain representative embodiments, a WTRU may be configured to determine the tracking path based on downlink measurements (e.g., of the configured DL-PRS resources) from one or more TRPs. In an example, in a case where a WTRU is configured with DL-PRS resources from more than one TRPs, the WTRU may be configured with a reference TRP. A WTRU may perform be configured to determine the path ID for tracking based on the measurement of DL-PRS resource from the reference TRP. A WTRU may be configured to determine a reference TRP for tracking based on at least one of various conditions. In an example, a condition may be that the distance between the TRP and WTRU, distance between the TRP and tracking object, distance between the WTRU and tracking object, or distance between any one of the TRP, WTRU or tracking object is below or above a threshold. In an example, a condition may be that at least one measurement of the DLPRS associated with the TRP or that the distance between at least a first path measurement with respect to a second path measurement is above or below a threshold.

In certain representative embodiments, a WTRU may be configured to determine a tracking path ID based on measured DL-PRS resources. A WTRU may be configured with a reference DL-PRS ID where it may perform the measurements to determine the tracking path ID. A WTRU may be configured to determine the tracking DL-PRS resource ID based on at least one of a variety of factors. In an example, a factor may be that at least one measurement (e.g., RSRP, SNR, Doppler spread, delay spread) based of the measured DL-PRS is above or below a threshold. In an example, a factor may be that the difference between at least one measurement between two measurement occasions is above or below a threshold. In an example, a DL-PRS resource may be spatially aligned with a tracking area. For example, a DL-PRS resource may be spatially aligned such that the spatial beam direction of the PRS resource is aligned to the indicated tracking area (e.g., zone ID, coarse area, reference location) or that at least one measurement (e.g., relative delay) of the PRS resource ID is within a reference measurement range (e.g., reference relative delay range). In an example, a factor may be that difference between at least one path measurement and another path measurement (e.g., reference path, LoS path) of the PRS resource ID is above or below a threshold. In an example, a factor may be that at least one statistic (e.g., variance) associated with at least one measurement is above or below a threshold.

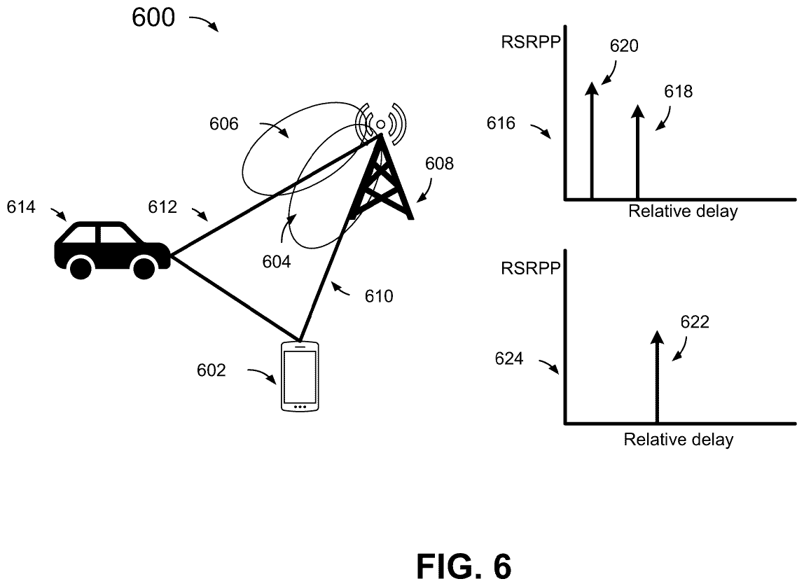

FIG. 6 shows scenario 600 of a WTRU determining a reference DL-PRS for tracking based on a reference path, according to one or more embodiments of this disclosure. WTRU 602 may receive DL-PRS 604 and DL-PRS 606 from TRP 608. Based on a path measurement, WTRU 602 may determine that measurements corresponding to DL-PRS 604 contain LoS path 610. WTRU 602 may also determine that measurements corresponding to DL-PRS 606 do not contain LoS path 610 but contain another path 612. Path 612 may be used as the tracking path to track object 614. WTRU 602 may determine DL-PRS 604 is the reference DL-PRS if path 612 (i.e., the tracking path) is present in both resource measurements, but LoS path 610 is only contained in DL-PRS 604. For example, RSRPP versus relative delay graph 616, which corresponds to measurements with DL-PRS 604, may contain RSRPP measurement 618 corresponding to path 612 and RSRPP 620 corresponding to LoS path 610. Meanwhile, RSRPP versus relative delay graph 624, which corresponds to measurements with DL-PRS 606, may only contain RSRPP measurement 622 corresponding to path 612.

In certain representative embodiments, if a WTRU determines the reference TRP, the WTRU may determine the reference DL-PRS as one of the configured PRS resource of the reference TRP. A WTRU may be configured to report to the network if at least one of the DL-PRS resource, DL-PRS beam, or DL-PRS resource set includes a reference path measurement (e.g., LoS path).

In certain representative embodiments, a WTRU may receive at least one indication of a tracking path from the network. A WTRU may receive at least one path indication from the network indicating the path that the WTRU may track. In an example, the tracking path IDs may be a path ID reported by the WTRU to the network. A WTRU may receive the indication in downlink physical channels (e.g., PDSCH or PDCCH, via higher layer signaling such as MAC-CE, RRC, DCI or via LPP messages) from the network.

In certain representative embodiments, a WTRU may be configured to determine the tracking path based on downlink measurements. In an example, a WTRU may perform DL-PRS measurements to determine the tracking path such that measurements are performed on at least one of the indicated or determined reference TRPs or reference PRS resource IDs.

In certain representative embodiments, a WTRU may determine a measured path as a tracking path based on at least one of a variety of reasons. In an example, a WTRU may determine a measured path as a tracking path based on at least one of a path having a measurement value, a difference between at least two measurement occasions, or a statistic associated with at least one path being above or below a threshold. In an example, a WTRU may determine a measured path as a tracking path based on if a path with at least one measurement is spatially aligned with at least one indicated tracking area. For example, a measured path may be spatially aligned such that the path has an AoA spatially aligned with an indicated tracking area (e.g., zone ID, coarse area, reference location) or that the path has at least one measurement (e.g., relative delay) within the indicated reference measurement range (e.g., relative delay range). In an example, a WTRU may determine a measured path as a tracking path based on if a path with at least one measurement is not spatially aligned with a restricted tracking area. For example, a measured path may not be spatially aligned such that the path has an AoA not spatially aligned with an indicated restricted tracking area (e.g., zone ID, coarse location, reference location) or that the path has at least one measurement (e.g., relative delay) that is not within an indicated restricted reference measurement range (e.g., relative delay range).

In certain representative embodiments, a WTRU may determine that more than one measured paths may be associated with the same object. In an example, a large object (e.g., building or a large vehicle) may contribute to more than one measured multipath component. A WTRU may be configured to determine an association between paths that may correspond to the same object based on various conditions. In an example, a condition may be that the difference between at least one of the measurements between two paths are above or below a threshold. For example, a WTRU may determine that two paths may correspond to the same object if the difference between the relative delay or the AoA for the paths are below a threshold.

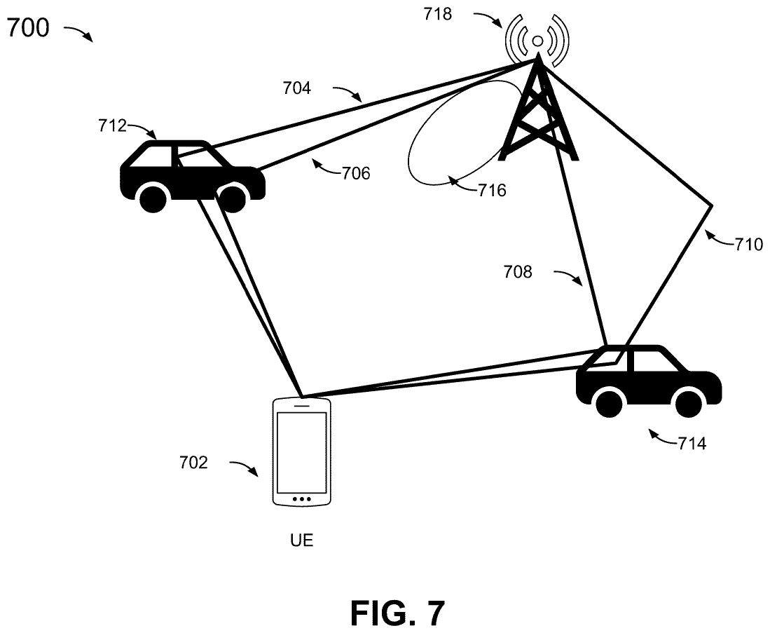

FIG. 7 shows scenario 700 of a WTRU determining that multiple paths exist for tracking, according to one or more embodiments of this disclosure. WTRU 702 may determine the existence of path 704, path 706, path 708, and path 710 for tracking. WTRU 702 may be configured to associate certain paths with each other based on the condition of a measurement difference exceeding a threshold. For example, WTRU 702 may determine that path 704 and path 706 have an AoA difference below a threshold. WTRU 702 may determine path 704 and path 706 are used to track object 712 and report the association of the paths to the network. Likewise, WTRU 702 may determine path 708 and path 710 are used to track object 714 and report the respective association of the paths to the network. WTRU 702 may receive DL-PRS 716 from TRP 718.

In certain representative embodiments, a WTRU may be configured to maintain one or more than one tracking paths wherein the tracking paths may be associated with at least one object. Multiple paths may serve as an alternative tracking path in case one of the paths are blocked. A WTRU may be configured to assign an identifier (e.g., tracking object ID) to one or more path IDs based on an association between two paths.

In certain representative embodiments, a WTRU may be configured to report at least one of a tracking object ID, a tracking path ID, a tracking DL-PRS resource ID, a tracking DL-PRS beam ID, a tracking DL-PRS resource set ID, a measurement (e.g., path measurement) associated with each reported tracking path ID, a statistic (e.g., variance) of a measurement associated with each reported tracking path ID, a DL-PRS resource ID, DL-PRS resource set ID, DL-PRS beam ID associated with each reported tracking path ID, a timestamp associated with a measurement (e.g., in terms of time index units), or a WTRU location (e.g., 2D location, 3D location).

In certain representative embodiments, a WTRU reporting, to a network, at least one of a tracking path or tracking DL-PRS ID (e.g., based on downlink measurement) may be considered as a request by the WTRU to perform tracking (e.g., uplink tracking).

In certain representative embodiments, a WTRU receives DL-PRS configurations for sensing which may include a reference DL-PRS ID and a tracking area indication (e.g., maximum AoA and minimum AoA thresholds). A WTRU may perform path measurements on the reference DL-PRS ID and determine a path as a tracking path based on conditions such as a measured RSRPP of a path being above a threshold or that a measured AoA of a path is within an AoA range. A WTRU may report the tracking path ID and the associated measurements to the network. A WTRU may receive an SRSp configuration for tracking which may include the tracking path ID.

In certain representative embodiments, a WTRU may receive at least one SRSp configuration from a network (e.g., LMF, gNB, of entity that configures reference signals to the WTRU) through downlink physical channels (e.g., PDSCH or PDCCH, via higher layer signaling such as MAC-CE, RRC, DCI or via LPP messages). In an example, a WTRU may be preconfigured with at least one SRSp configuration such that each SRSp configuration may be associated with at least one of an SRSp configuration ID, transmission configuration indication (TCI-state) ID, TCI-state UL ID, time window ID, time window configuration, DL-PRS ID, DL-PRS configuration, or tracking area. A WTRU may receive a configuration or indication from a network through downlink physical channels (e.g., PDSCH or PDCCH, via higher layer signaling such MAC-CE, RRC, DCI, or via LPP messages) from the network. A WTRU may send a request or a measurement report via a semi-static (e.g., LPP, RRC), dynamic message (e.g., UCI, MAC-CE), or uplink channel (e.g., PUCCH, PUSCH).

In certain representative embodiments, a WTRU may be configured to determine the transmission power for uplink SRSp transmission for tracking at least one path. A WTRU may determine the transmission power for tracking based on variety of manners.

In certain representative embodiments, a WTRU may receive an indication from the network with the SRSp transmission power including at least one a tracking object ID, a tracking path ID, an SRSp resource ID (e.g., TCI-state ID, TCI-UL state ID), SRSp resource set ID, SRSp beam ID, a time window indication, a transmission power value, a DL-PRS resource ID (e.g., TCI-state ID, TCI-UL state ID), DL-PRS beam ID, DL-PRS resource set ID, or an indication of tracking area.

In certain representative embodiments, a WTRU may determine to transmit an indicated SRSp resource (e.g., SRSp resource ID) with an indicated transmission power. In an example, the WTRU may determine to transmit a SRSp resource ID associated with at least one of an object ID or tracking path ID with the indicated SRSp transmission power.

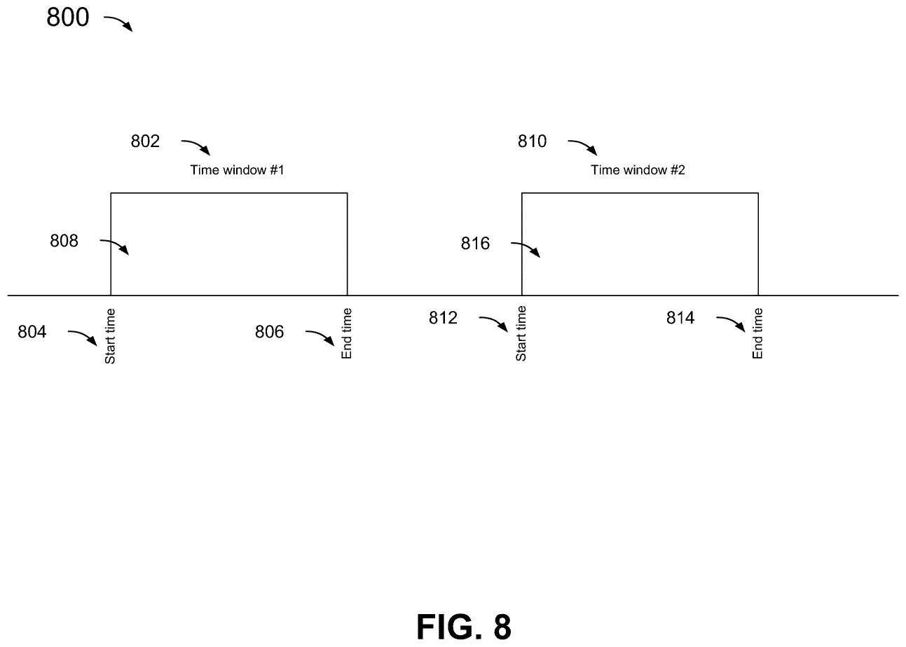

FIG. 8 shows model 800 of time windows with associated powers, according to one or more embodiments of this disclosure. Time window 802 may have a start time 804 and end time 806. Time window 802 may be associated with power 808. For example, a WTRU may determine to transmit SRSp resources from start time 804 to end time 806 with power 808. Likewise, time window 810 may have start time 812 and end time 814. Time window 810 may be associated with power 816. A WTRU may determine to transmit SRSp resources from start time 812 to end time 814 with power 816.

In certain representative embodiments, a WTRU may be configured to transmit SRSp resources with an indicated transmission power during activation of the indicated measurement window.

In certain representative embodiments, a WTRU may determine to transmit tracking path IDs associated with at least one of indicated DL-PRS resource IDs, DL-PRS beam IDs, or DL-PRS resource set IDs with an indicated transmission power. In an example, a WTRU may be configured to transmit the SRSp resources (e.g., QCL type D or spatial relationship information) with the indicated DL-PRS resources with the indicated transmission power. A WTRU may determine to transmit the SRSp resources spatially aligned to the at least one of the indicated tracking areas with the indicated transmission power.

In certain representative embodiments, a WTRU may be configured to determine a transmission power for tracking a path based on assistance information. A WTRU may be configured for the purpose of tracking and may be configured to determine the transmission for SRSp transmission. In an example, a transmission power may enable the gNB to monitor the changes in measurement due to changes in the object state such as translational or rotational mobility. Such changes may also enable the gNB to determine the reflection characteristic of the object.

In certain representative embodiments, a WTRU may be configured to determine an SRSp transmission power to enable tracking of an object or a path within an indicated tracking area. In an example, a WTRU may be configured to determine the transmission power for tracking based on the configured reference measurement range. A WTRU may determine the transmission power based on the spatial information of the area where the WTRU may track the object. In an example, a WTRU may determine to request a transmission power for SRSp resources based on an indicated (e.g., maximum, minimum) reference measurement (e.g., relative delay, AoA, doppler shift) for tracking being above or below a threshold. In an example, a WTRU may determine to request a transmission power for SRSp resources based on the distance between the WTRU and the indicated object location being above or below a threshold. In an example, a WTRU may determine to request a transmission power for SRSp resources based on the distance between a TRP and the indicated object location being above or below a threshold. In an example, a WTRU may determine to request a transmission power for SRSp resources based on the distance between at least one of the WTRU, the indicated object location, or the TRP being above or below a threshold. In an example, a WTRU may determine to request a transmission power for SRSp resources based the distance between the WTRU and the indicated tracking area being above or below a threshold. In an example, a WTRU may determine to request a transmission power for SRSp resources based on the WTRU being located within a tracking area, the object being located within a tracking area, the object being located outside a restricted tracking area, the WTRU being located outside of a restricted tracking area, a WTRU velocity being above or below a threshold, or the distance between the WTRU and reference location being above or below a threshold.

In certain representative embodiments, a WTRU may be configured with the relationship between the transmission power and the sensing range that the WTRU may determine to track an object within (e.g., based on mapping tables, equations). A WTRU may determine the transmission power for an indicated range. A WTRU may determine the range based on at least one of a location within an indicated tracking area (e.g., center of the tracking area), the WTRU location, or the TRP location. In an example, a WTRU may determine the sensing range based on an object location.

In certain representative embodiments, a WTRU may be configured with a tracking area in terms of a maximum relative delay duration. A WTRU may then determine the sensing range based on one or more of its location, TRP location, or the distance corresponding to the relative delay duration. A WTRU may then determine the transmission power based on the mapping of the sensing range to transmission power based on mappings such as equations or tables.

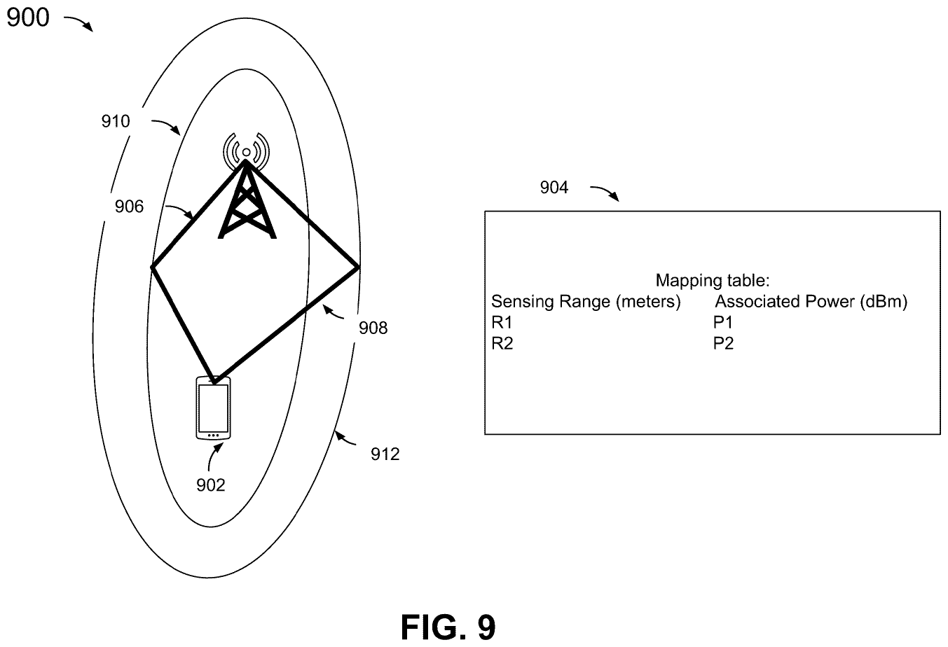

FIG. 9 shows scenario 900 of a WTRU configured with a mapping table, according to one or more embodiments of this disclosure. In scenario 900, WTRU 902 may be configured with mapping table 904. Mapping table 904 may include a mapping with different transmission powers and sensing ranges. For example, WTRU 902 may be configured with a sensing range R1 and associated power P1 for path 906. Likewise, WTRU 902 may be configured with sensing range R2 and associated power P2 for path 908. WTRU 902 may determine that transmission power based on a respective sensing range. WTRU 902 may use path 906 to track objects in area 910 and may use path 908 to track objects in area 912.

In certain representative embodiments, a WTRU may determine transmission power based on indicated object information. In an example, a WTRU may determine the sensing range based on the indicated object location and determine the transmission power based on the location. In an example, a WTRU may determine the transmission power based on the object material or radar cross section information. A WTRU may determine to transmit a transmission power if the RCS is above a threshold.

In certain representative embodiments, a WTRU may be configured to determine the transmission power based on at least one downlink measurement. A WTRU may be configured to determine the transmission power by the network based on at least one of the measurements of DL-PRS resources for the indicated tracking path (e.g., based on open loop power control). A WTRU may receive at least one power control configuration including at least one tracking path ID, SRSp resource ID, maximum power that may be transmitted by the WTRU, an indication that the target received power has the required strength to determine measurements, an indication for a path-loss compensation factor, or path-loss information (e.g., tracking path indication, tracking DL-PRS ID indication, or pathloss value).

In certain representative embodiments, a WTRU may be configured to determine the SRSp transmission power based on the measured RSRPP of the tracking path. In an example, a WTRU may determine the transmission power based on an equation such as

$${P}_{Tx} = min \{ \frac{P max}{P 0 + 10 {log}_{10} {2}^{μ} M + α {PL}_{sensing}} \} dBm .$$

In the above equation, the WTRU may determine the path loss based on at least one of the transmission power of the measured DL-PRS resource (e.g., indicated by the network to the WTRU), the measured RSRPP of at least one path (e.g., LoS path, tracking path), or the RSRP of the measured DL-PRS resource.

In certain representative embodiments, a WTRU may receive the path loss value from the network and determine the transmission power as a function of path loss. A WTRU may be configured with a mapping table or an equation for determining transmission power as a function of path loss.

In certain representative embodiments, a WTRU may be configured to determine the pathloss value for the tracking path. A pathloss (e.g., for the tracking path) may be defined as the difference between transmission power of measured tracking DL-PRS resource and RSRPP of the tracking path. In an example, the pathloss for the tracking path may be defined as the difference between the transmission power of measured tracking DL-PRS resource and RSRPP of the LoS path. In an example, the pathloss for the tracking path may be defined as the difference between the transmission power of measured DL-PRS resource and RSRP of the tracking DL-PRS resource.

In certain representative embodiments, a WTRU may receive an indication of a transmission power model which the WTRU may determine the transmission power with. A WTRU may be configured to request the network with the transmission power model based on at least one of a variety of conditions. In an example, a condition may be that the duration between the downlink measurement occasion (e.g., associated with the path loss measurement, associated with determination of the tracking path) and the transmission of SRSp resources for tracking is above or below a threshold. In an example, a condition may be that at least one of the measurements (e.g., RSRPP, doppler shift) of at least one of the measured paths (e.g., tracking target path) is above or below a threshold. In an example, a condition may be that the difference between at least one of the measurements (e.g., RSRPP, AoA) of at least one of the measured path (e.g., tracking target path) is above or below a threshold. In an example, a condition may be that the duration between the SRSp transmission occasions is above or below a threshold. In an example, a condition may be that at least one statistic (e.g., variance) of a measurement is above or below a threshold. In an example, a condition may be that the WTRU may receives an indication from the network.

In certain representative embodiments, a WTRU may be configured with the transmission power model from the network. A WTRU may be configured with at least one of an SRSp resource ID, tracking path ID, mapping equation, function or table (e.g., defining a mapping of transmission power with at least one of transmission time, measurement value, WTRU velocity, WTRU location, or object information), or a parameter associated with a mapping equation.

A transmission power model may be a power ramping model such that the WTRU is configured to increase the transmission power from the first occasion to the second occasion by a certain value. In an example, a WTRU may be configured with a specific power ramping value and hence may determine to increase or decrease the transmission power by the indicated value compared to the previous transmission occasion. A WTRU may either receive the power ramping value or an index to a power ramping value associated with the index. The transmission power determination based on the power ramping value may be defined based on the following equation:

$${P}_{Tx} ( k + i ) = max ( P max , P ( k ) + i Δ ) .$$

In the above equation, P(k) is the transmission power in the k-th time instance and the WTRU determines to increase the transmission power linearly based on the different occasions such that in the (k+i)th occasion, the transmission power is a increased to iΔ compared to the kth occasion. In the above equation, Pmax limits the transmission maximum power to a fixed value.

In certain representative embodiments, a WTRU may be configured with at least one equation or a mapping function (e.g., in terms of mapping table) which the WTRU may determine to model the transmission power model with. In an example, the WTRU may receive an indication with the coefficients of a function to map the transmission power to use for different transmission occasion.

In certain representative embodiments, a WTRU may be configured by the network to determine the transmission power model. A WTRU may determine the transmission power model based on at least one of a transmission power of the measured DL-PRS resource (e.g., as indicated by the network to the WTRU) or at least one measurement (e.g., path measurement associated with the tracking path) association with at least one DL-PRS measurement occasion. A WTRU may be configured to determine the transmission power based on at least one measurement in addition to the RSRPP or RSRP measurement to determine the path loss. In an example, a WTRU may determine that the duration between the measurement occasion and the transmission occasion is above a threshold. In addition, a WTRU may determine (e.g., based on the Doppler shift measurement) that the tracking path is mobile (e.g., relative to the WTRU) and hence path loss based only on the RSRPP measurement may not accurately indicate the path loss value. A WTRU may determine that the path loss must based on at least one measurement other than the RSRP or RSRPP associated with the path.

In certain representative embodiments, a WTRU may be configured with a mobility model or the trajectory of the target. In an example, a WTRU may receive a time varying mobility model (e.g., considering the object location, velocity or acceleration) and the WTRU may determine the transmission power based on the estimated location of the target object. In an example, a WTRU may determine the estimated object location based on the object's trajectory and object information such as object velocity. A WTRU may determine the sensing range based on the estimated object location or object information during the SRSp transmission time. A WTRU may determine the transmission power based on the estimated sensing range.

In certain representative embodiments, a WTRU may be configured by the network to determine the transmission power based on at least one or more downlink measurements in at least one or more measurement occasions. In an example, a WTRU may be configured by at least one of a time window indication (e.g., start or stop time) or a measurement occasion indication (e.g., measurement configuration ID or reporting occasion ID) to determine the measurements occasions to consider for transmission power determination. In an example, a WTRU may determine measurement occasions to consider for determining the SRSp transmission power based on at least one of the occasions with at least one measurement (e.g., RSRPP) corresponding to at least one path (e.g., tracking path) being above a threshold, the occasions with at least one statistic (e.g., variance) corresponding to at least one measurement (e.g., RSRPP) of at least one path (e.g., tracking path) being above a threshold, or the occasions with duration between the SRSp transmission occasion being above or below a threshold.

In certain representative embodiments, a WTRU may determine the transmission power based on at least one of the time durations between the DL-PRS measurement occasions and the SRSp transmission occasion or at least one measurement (e.g., associated with the tracking path, such as AoA, doppler shift) from one of the measurement occasions.

In certain representative embodiments, a WTRU may be configured to determine the SRSp transmission power for transmission. The determination may be based on one or more measurement occasions. In an example, the WTRU may perform an analysis using regression (e.g., linear, non-linear) or artificial intelligence on the measurement information from one or more occasions to determine the transmission power sequence. The determination of model coefficients may be based on one or more measurements.

A WTRU may be configured to determine the transmission power based on a preconfigured model (e.g., regression). A WTRU may determine respective path losses based on measurements from previous occasions. A WTRU may determine the pathloss as a function of respective path losses such that the function may be indicated by the network to the WTRU. A WTRU may determine to use the RSRPP measurement associated with at least one or more measurement occasions associated with a path (e.g., tracking path) to determine the RSRPP sequence during a certain number of transmission occasions and hence to determine the path loss and the transmission power sequence. A WTRU may determine the rate of change of at least one measurement (e.g., RSRPP, AoA, Doppler shift) to determine the rate of change of transmission power for different SRSp transmission occasions.

In certain representative embodiments, a WTRU may receive feedback (e.g., closed loop power control) from the network to change the transmission power associated with the SRSp transmission for tracking a path. A WTRU may receive a variety of different types of information for power adjustment. In an example, a type of information for power adjustment may be an indication of an at least one differential power adjustment value which the WTRU may apply to the SRSp transmission power. In an example, a type of information for power adjustment may be at least one transmission occasion which the WTRU may determine to adjust the transmission power based on. In an example, a type of information for power adjustment may be at least one tracking path ID to apply the power adjustment to. In an example, a type of information for power adjustment may be at least one tracking object ID indication. In an example, a type of information for power adjustment may be at least one SRSp resource ID where the WTRU may apply the power adjustment to.

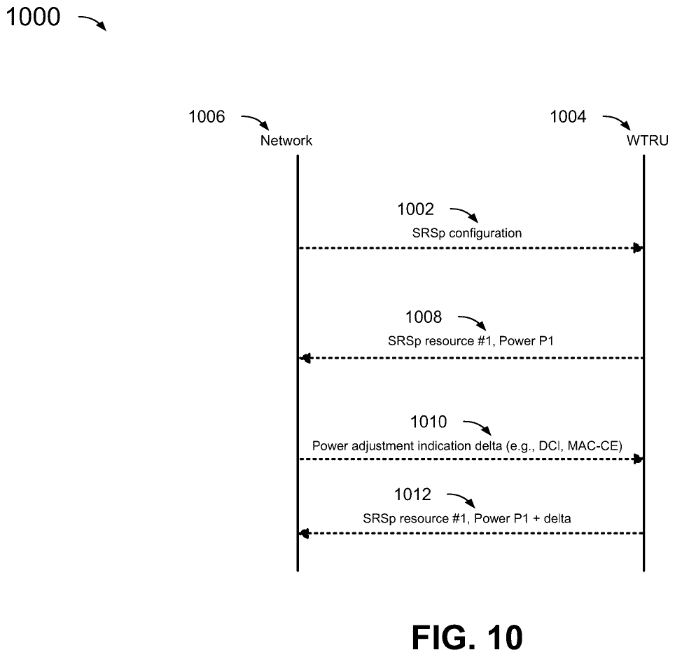

FIG. 10 shows procedure 1000 for power adjustment for a WTRU, according to one or more embodiments of this disclosure. At operation 1002, WTRU 1004 may receive an SRSp configuration from network 1006. At operation 1008, WTRU 1004 may transmit an SRSp resource and a respective power to network 1006. At operation 1010, WTRU 1004 may receive a power adjustment indication delta (e.g., via DCI or MAC-CE) from network 1006. At operation 1012, WTRU 1004 may transmit an SRSp resource and a respective power adjusted by some delta from operation 1010 to network 1006.

In certain representative embodiments, a WTRU may be configured with a maximum or a minimum transmission power. A WTRU need not exceed the indicated maximum transmission power or go below the minimum transmission power. If the transmission power (e.g., indicated or determined by the WTRU) exceeds the maximum transmission power, the WTRU may either transmit with the maximum transmission power or terminate the tracking procedure. A WTRU may report to the network that the transmission power (e.g., indicated or determined) has reached the maximum transmission power.

In certain representative embodiments, a WTRU may be configured with a sequence of transmission power which the WTRU may determine to use for the at least one or more transmission occasions. In an example, the WTRU may request and/or receive the sequence of transmission power for more than one occasions from the network based on at least one condition from a variety of conditions. In an example, a condition may be that at least one of the measurements, difference between at least one measurement, or statistic associated with at least one measurement is above or below a threshold. In an example, a condition may be if a WTRU mobility value (e.g., velocity, rotation) or object mobility is above or below a threshold. In an example, a condition may be if a WTRU's location or if an object's location is within a tracking area. In certain representative embodiments, the WTRU may receive an indication from the network to stop transmission with the configured transmission power or the sequence of transmission power if at least one of the conditions from the above-mentioned variety of conditions are not satisfied.

In certain representative embodiments, a WTRU may be configured to request or determine the transmission power in more than one SRSp transmission occasions to avoid having to perform measurements before every transmission occasion. Performing measurements before every transmission may create overhead to the WTRU in terms of processing. Signaling from the network also may create signaling overhead. As a result, if a WTRU determines that measurement conditions are satisfied, the WTRU may request or determine the transmission power for more than one occasion. In an example, a WTRU may receive a sequence of transmission powers from the network. Each transmission power may be associated with an occasion indication. The sequence of occasions (e.g., indicated by the network) may be in terms of at least one of a sequence of transmission occasion indices, a sequence of transmission timings such that the timing may be an absolute timing or a timing duration relative to a reference timing, or a sequence of at least one of an SRSp resource ID, SRS beam ID, or SRSp resource set ID.

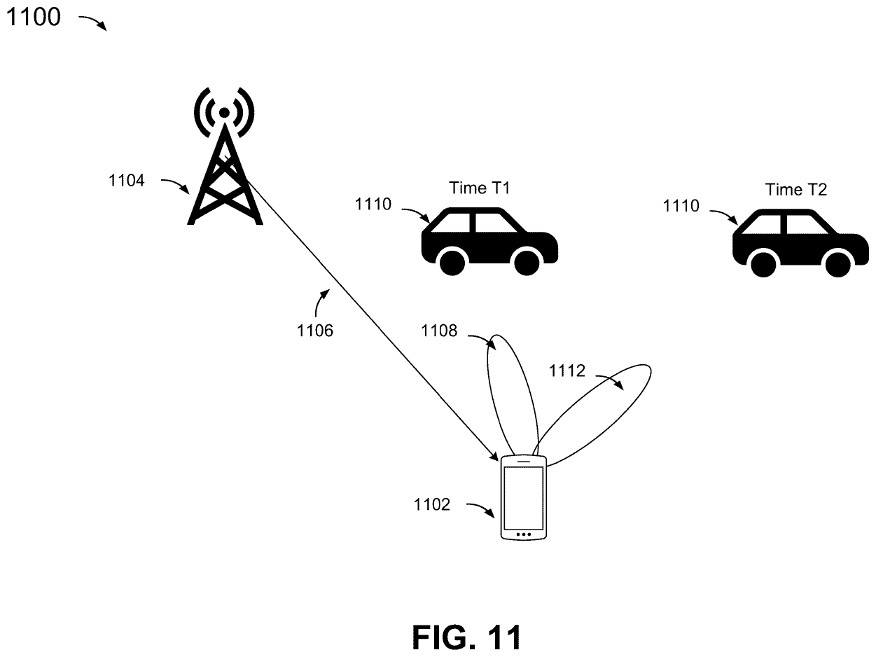

FIG. 11 shows scenario 1100 of a WTRU receiving a sequence of transmission powers and a sequence of transmission times, according to one or more embodiments of this disclosure. In scenario 1100, WTRU 1102 may receive a sequence 1106 of transmission powers and transmission times from TRP 1104 (e.g., via MAC-CE layer). WTRU 1102 may transmit the SRSp resources in the indicated time with the indicated resource with the indicated transmission power from sequence 1106. For example, WTRU may transmit SRSp resource 1108 for target 1110 at a first time and first power corresponding to a first time and first power from sequence 1106. Likewise, WTRU may transmit SRSp resource 1112 for target 1110 at a second time and second power corresponding to a second time and second power from sequence 1106.

In certain representative embodiments, a WTRU may receive a sequence of differential powers for transmission in at least one or more transmission occasions. A WTRU may receive at least one of a sequence of differential powers, a sequence of transmission locations, a reference occasion (e.g., a first SRSp transmission occasion), a tracking path ID, or a transmission power for the reference occasion. In an example, a WTRU may determine the transmission power for a certain number of occasions based on adding the differential powers to the transmission power in the reference occasion. In an example, a WTRU may determine to transmit the sequence of transmission powers as a sequence of values such that a given sequence value is the transmission power from the reference occasion added to the power from a given occasion.

In certain representative embodiments, a WTRU may be configured to determine the sequence of transmission powers by the network for a sequence of transmission occasions based on a configured or determined model by the network. In an example, a WTRU may be configured to determine the transmission power corresponding to a certain number of occasions from the network. A WTRU may determine the transmission power based on a configured model where the output of the model or the function may be the transmission power corresponding to the give number of occasions.

In certain representative embodiments, a WTRU may be configured with a sequence of transmission powers. In an example, the transmission power or the sequence of transmission powers may be associated with at least one of an SRSp resource ID, SRSp resource set ID, SRSp beam ID, tracking area, time window ID, DL-PRS resource ID, DL-PRS beam ID, DL-PRS resource set ID, TCI-state ID, or TCI-UL state ID.

In certain representative embodiments, a WTRU may determine to report the determined SRSp transmission power with which it may perform uplink transmissions. A WTRU may report at least one of SRSp transmission occasions (e.g., transmission occasion index), transmission SRSp resource ID, beam ID, resource set ID, determined SRSp transmission time (e.g., sequence of transmission time), one path index (e.g., path ID), one measurement associated with at least one path (e.g., tracking path ID), timestamp associated with the reported measurements, transmission power, coefficients or parameters of the model used to determine the transmission power, or TRP ID intended for SRSp reception.

In certain representative embodiments, a WTRU may subsequently receive an acknowledgment (ACK) or a negative acknowledgment (NACK) message from the network indicating whether to transmit with the determined transmission power or not.

In certain representative embodiments, a WTRU may receive an indication with a transmission beam to use for SRSp transmission. A WTRU may receive at least one of an SRSp resource ID, SRSp resource beam ID, SRSp resource set ID, TCI-state ID, TCI-UL state ID, indication of spatial direction, a tracking path ID, or a time window ID for the SRSp transmission beam.

In certain representative embodiments, a WTRU may receive an indication from the network to activate, deactivate, or switch the transmission beam for the SRSp transmission. In an example, a WTRU may receive SRSp spatial information (e.g., SRSp resource ID, TCI-UL State ID, DL-PRS ID with spatial association to the SRSp resource) indicating to the WTRU to change the SRSp transmission beam. In an example, a WTRU may be configured to determine the SRSp transmission beam for SRSp transmission based on at least one of an indication from the network, the number of paths based on the downlink measurement exceeding a threshold, or if the WTRU determines that at least one of the measurements exceeds a threshold.

A WTRU may determine a spatial direction of the SRSp transmission beam for the tracking path based on at least one of a variety of factors. In an example, a factor may be a measurement of at least one of the measured paths (e.g., AoA of the tracking path). In an example, a factor may be the receiving spatial filter of the reference DL-PRS associated with the tracking path. In an example, a factor may be a receiving spatial filter of the measured DL-PRS resource with at least one of the DL-PRS resource with at least one measurement (e.g., RSRP, SINR, SNR) exceeding a threshold, DL-PRS resource with at least one path measurement (e.g., tracking path measurement such as RSRPP, AoA) of at least one path (e.g., LoS path, tracking path, or a first path) exceeding a threshold, or DL-PRS resource indicated with spatial relationship information with the transmission SRSp resources, SRSp beam and/or SRSp resource set. In an example, a factor may be spatial information such as the tracking area such that the WTRU may determine the spatial direction in a way that aligns with the indicated spatial information in the tracking area. A WTRU may determine the beamwidth of the SRSp resource set based on at least one of a measurement (e.g., RSRP, delay spread) associated with the determined reference DL-PRS resource, a path measurement of at least one of the paths associated with the determined reference DL-PRS resource, a statistic of at least one of the measurements, or the total number of measured paths on at least one of the measured DL-PRS resources.

In certain representative embodiments, a WTRU may receive an indication of a model that the WTRU may utilize to determine a transmission beam. A WTRU may be configured to request the network with the transmission beam model based on at least one of the same conditions associated with requesting the transmission power model. In an example, a WTRU may be configured with at least one equation or a mapping function (e.g., in terms of mapping table) to determine the transmission beam. For example, the WTRU may receive an indication with the coefficients of a function to map the transmission power to use for different transmission occasions. The mapping equation or function may be a function to determine the transmission beam or the spatial direction (e.g., angle) of transmission. The function may intake at least one of a transmission time, measurement value, WTRU velocity, WTRU location, or at least one type of object information as an argument.

In an example, a WTRU may be configured to determine the SRSp beam model based on downlink measurements. A WTRU may be configured to determine the sequence of beams based on measurement occasions. A WTRU may determine the occasions based on same conditions as for determining occasions for transmission power determination. In an example, a WTRU may determine the sequence of transmission beams based on at least one of a measurement, a change of at least one measurement between the measurement occasions, measurement statistic, or a WTRU mobility value exceeding a threshold.

In an example, a WTRU may receive an association of a sequence of the SRSp transmission times with a sequence of the SRSp transmission beams in terms of at least one of a sequence of SRSp resource IDs, SRSp beam IDs, SRSp resource set IDs, TCI-state IDs, TCI-UL state IDs, DL-PRS resource IDs, DL-PRS beam IDs, or DL-PRS resource set IDs. A sequence may indicate to the WTRU to transmit the associated SRSp resources, beams, or resource sets. In an example, a WTRU may receive an association of a sequence of the SRSp transmission times with a sequence of SRSp transmission beams in terms of at least one of a sequence of transmission occasion index, a sequence of transmission timings such that timing may be an absolute timing or a timing duration relative to a reference timing, a sequence of SRSp resource IDs, SRS beam IDs, or SRSp resource set IDs, or a time window ID. In an example, a WTRU may be configured to determine a sequence of SRSp transmission beams for tracking based on at least one of receiving an indication from the network, determining that at least one measurement associated with at least one path exceeds a threshold, determining that a change in at least one measurement associated with at least one path exceeds a threshold, determining that the WTRU's velocity exceeds a threshold, or determining that a duration between two SRSp transmissions exceeds a threshold.

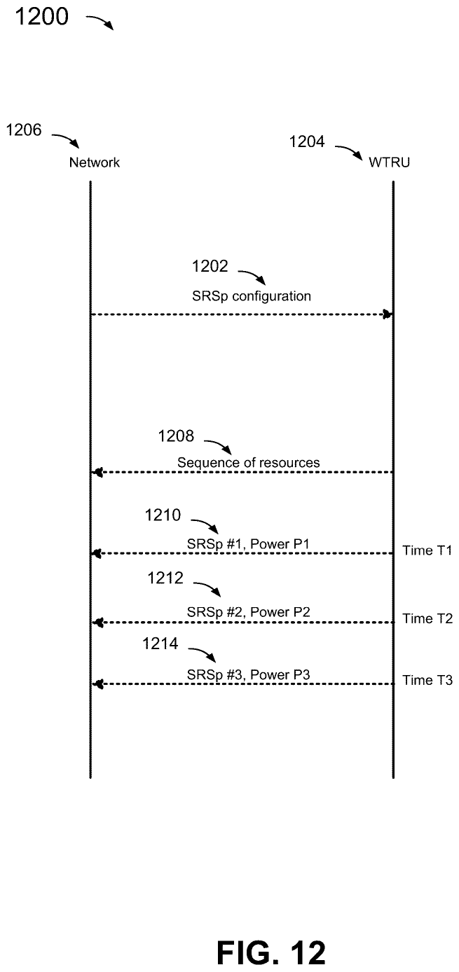

FIG. 12 shows procedure 1200 of a WTRU receiving a sequence of resources and performing transmissions based on the sequence, according to one or more embodiments of this disclosure. At 1202, WTRU 1204 may receive an SRSp configuration from network 1206. At 1208, WTRU 1204 may transmit a sequence of resources including an SRSp power sequence, SRSp transmission beam sequence, and SRSp time sequence. More specifically, at 1210, 1212, and 1214, WTRU 1204 may transmit an SRSp with a power, or any other resource, specified from a sequence from 1208 at respective indicated times.

In certain representative embodiments, a WTRU may determine the sequence of transmission beams for one or more of the SRSp transmission occasions. A WTRU may determine the sequence of transmission beams based on a configured transmission beam model. A WTRU may determine to report the determined SRSp transmission beam used to perform uplink transmissions. A WTRU may report any one of SRSp transmission occasions, transmission SRSp resource IDs, beam IDs, resource set IDs, SRSp transmission times, path indices, a measurement associated with at least one path, a measurement associated with at least one of the DL-PRS resources, an indication if a reference path is measured with at least one DL-PRS resource ID, an indication if a reference path is measured with an SRSp beam or SRSp resource ID, a timestamp associated with the reported measurements, transmission beams, coefficients or parameters of the model used to determine the transmission power, or a TRP ID intended for SRSp reception.

In certain representative embodiments, a WTRU may receive a SRSp configuration for transmitting the SRSp resources for tracking. A WTRU may receive an indication from the network to activate at least one SRSp resource. In an example, a WTRU may be configured with at least one SRSp configuration such that an SRSp configuration may be associated with at least one of a transmission power, transmission beam or spatial direction of SRSp transmission, tracking area, time window ID, DL-PRS resource ID, DL-PRS beam ID, DL-PRS resource set ID, TCI-State ID, TCI-UL State ID, a tracking path ID, or a tracking area.

In certain representative embodiments, a WTRU may determine to activate or deactivate an SRSp configuration. In an example, a WTRU may receive an SRSp configuration with a transmission time window. A WTRU may receive an indication of association of SRSp resources with a certain transmission power or spatial direction for a transmission beam. A WTRU may determine to initiate transmission, with the configured resources, if it determines to begin transmission with the indicated power or in the indicated transmission spatial direction. In an example, a WTRU may receive an association of a tracking path ID with the SRSp configuration and may determine to use the configured resources with tracking the indicated path.

In certain representative embodiments, a WTRU may be configured to determine the SRSp configuration based on at least one of a measurement associated with at least one path measurement, a difference in at least one measurement between measurement occasions, a WTRU mobility value, or a transmission power exceeding a threshold. In an example, a WTRU may be configured to determine the SRSp configuration based on at least one determination that the WTRU is located in an indicated area, that a tracked object is located within an area, or that a tracked object exceeds a threshold. A WTRU may be configured to determine a sequence of SRSp configurations where at least one resource configuration may be used for transmit for at least one transmission occasion. A WTRU may be configured to report the determined SRSp configuration to the network.

In certain representative embodiments, a WTRU may receive an indication from the network to activate, deactivate, or switch at least one of an SRSp configuration, SRSp transmission power, SRSp transmission beam, SRSp transmission time, tracking path ID, tracking object ID, tracking DL-PRS resource ID, time window ID, or assistance information for determination of transmission power, transmission beam or SRSp configuration. The activation or deactivation of a tracking path may indicate to a WTRU to activate or deactivate the SRSp configuration associated with the tracking path. In an example, assistance information from the network may indicate to the WTRU to switch the transmission power or beam determination method, and the WTRU may determine to switch its SRSp configuration. In an example, an indication from the network to the WTRU for activation, deactivation, switching of power, beam, or SRSp configuration may be associated with at least one or more paths. The indication may be associated with at least one SRSp resource ID or SRSp beam ID, or SRSp resource set ID. A WTRU may determine to adjust the power, beam, or SRSp configuration for a particular indicated path. A WTRU may be configured to activate, deactivate or switch at least one of the SRSp configuration, SRSp transmission power, SRSp transmission beam, SRSp transmission time, tracking path ID, tracking object ID, tracking DL-PRS resource ID, time window ID, or assistance information for determination of transmission power, transmission beam or SRSp configuration based on a variety of conditions. In an example, a condition may be that a measurement of a tracking path, difference between at least one measurement between measurement occasions of the tracking path, statistic associated with at least one measurement of the tracking path ID, measurement associated with the tracking DL-PRS ID, difference in at least one measurement associated with the tracking DL-PRS ID, difference between at least one measurement associated with two paths, distance between the WTRU and the tracked object location, velocity of the tracked object, or velocity of the WTRU exceeds a threshold. The paths or the PRS resources for tracking may be associated with one or more TRPs.

In certain representative embodiments, a WTRU may be configured to report at least one of an activated, deactivated, or switched tracking path ID, measurement associated with at least one tracking path ID, SRSp configuration indications, or measurement timestamps to the network. A WTRU may receive an ACK or NACK message from the network in response. A WTRU may terminate a tracking procedure upon receiving the NACK command from the network. A WTRU may transmit the configured SRSp resources for tracking upon reception of the ACK command from the network.

In certain representative embodiments, a WTRU may determine to terminate a tracking procedure based on at least one of the WTRU receiving an indication from the network, determining that the number of paths exceeds a threshold, determining that there are no active tracking paths or tracking PRS IDs, or determining that there is a failure in satisfying a trigger condition for initiating a tracking procedure. A WTRU may indicate the termination of a tracking procedure to the network.

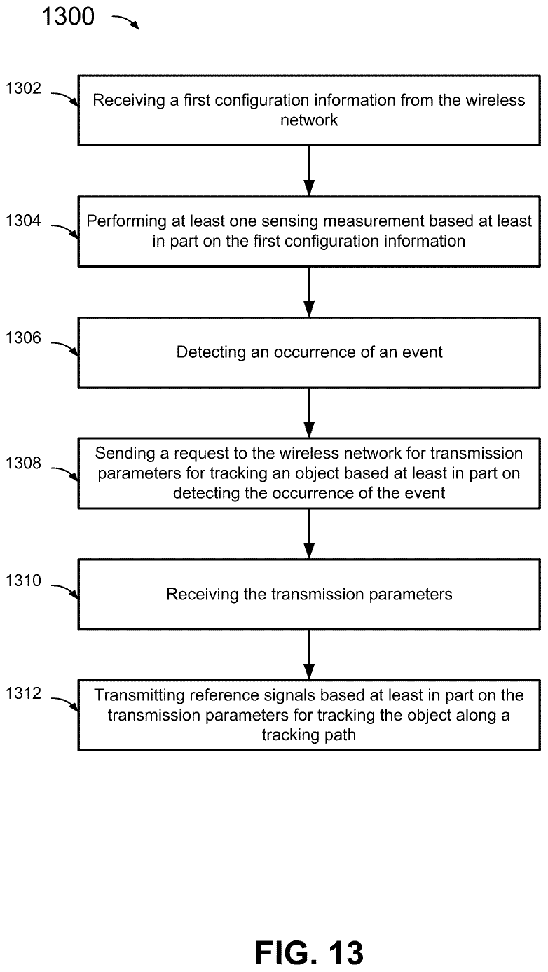

FIG. 13 shows flowchart 1300 of illustrative steps for power control and beam determination for tracking, according to one or more embodiments of this disclosure.

At 1302, a WTRU may receive, from a wireless network, a first configuration information (e.g., as in any one of FIGS. 2-7 and 9-12). A first configuration information may include at least one of a DL-PRS configuration, a reference DL-PRS ID, or assistance information for tracking. Assistance information for tracking may include at least one of a relative timing between a plurality of tracking paths, a tracking time window, a tracking region for the WTRU, a maximum tracking measurement value, a minimum tracking measurement value, or tracking object information. Tracking object information may include at least one of a location of the object, a velocity of the object, a trajectory of the object, a radar cross section of the object, a classification type of the object, a material of the object, or a timestamp associated with object information.

At 1304, a WTRU may perform at least one sensing measurement based at least in part on the first configuration information. A sensing measurement may be at least one of an RSRP, RSRPP, delay, relative delay, AoA, Doppler shift, delay spread, Doppler spread, RSTD, WTRU receiving-transmission time difference, RSCP, or reference signal phase difference.

At 1306, a WTRU may detect an occurrence of an event. The event may be at least one sensing measurement exceeding a threshold.

At 1308, a WTRU may send a request to the wireless network for transmission parameters for tracking an object based at least in part on detecting the occurrence of the event. Transmission parameters may include at least one of transmission power, transmission beam, or SRSp configuration information.

At 1310, a WTRU may receive transmission parameters (e.g., from a wireless network).

At 1312, a WTRU may transmit reference signals based at least in part on the transmission parameters for tracking the object along a tracking path. A WTRU may also be further configured to determine to track an object along a tracking path from a plurality of tracking paths based at least in part on a downlink measurement or a DL-PRS resource. A WTRU may also be further configured to determine that a plurality of tracking paths may be used to track the object (e.g., as in FIG. 7) and be configured to track the object using at least one tracking path from the plurality of tracking paths. A WTRU may be further configured to also transmit a request to the wireless network for a different device within a wireless network to track an object along a tracking path.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations or processes described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the means of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, or a computer memory, and a transmission type medium such as a digital and/or an analog communication medium (e.g., a fiber optic cable, a waveguide, a wired communications link, a wireless communication link).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to”). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together). In those instances where a convention analogous to “at least one of A, B, or C.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths. As a non-limiting example, each range discussed herein may be readily broken down into a lower third, middle third and upper third. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke means-plus-function claim format, and any claim without the terms “means for” is not so intended.

What is claimed is:

1. A method performed by a wireless transmit/receive unit (WTRU), the method comprising:
receiving, from a wireless network, first configuration information;
performing at least one sensing measurement based at least in part on the first configuration information;
detecting an occurrence of an event;
sending, based at least in part on detecting the occurrence of the event, a request to the wireless network for transmission parameters, wherein the transmission parameters are for tracking an object;
receiving, from the wireless network, the transmission parameters based on the request; and
transmitting reference signals based at least in part on the transmission parameters for tracking the object along a tracking path.

2. The method of claim 1, wherein the first configuration information indicates at least one of: a downlink-positioning reference signal (DL-PRS) configuration, a reference DL-PRS identification (ID), or assistance information for tracking.

3. The method of claim 2, wherein the assistance information for tracking comprises at least one of: a relative timing between a plurality of tracking paths, a tracking time window, a tracking region for the WTRU, a maximum tracking measurement value, a minimum tracking measurement value, or tracking object information.

4. The method of claim 3, wherein the tracking object information comprises at least one of: a location of the object, a velocity of the object, a trajectory of the object, a radar cross section of the object, a classification type of the object, a material of the object, or a timestamp associated with object information.

5. The method of claim 1, wherein the at least one sensing measurement is at least one of: reference signal received power (RSRP), reference signal received power per path (RSRPP), delay, relative delay, angle of arrival (AoA), Doppler shift, delay spread, Doppler spread, reference signal time difference (RSTD), WTRU receiving-transmission time difference, reference signal carrier phase (RSCP), or reference signal carrier phase difference (RSCPD).

6. The method of claim 1, wherein the event comprises the at least one sensing measurement exceeding a threshold.

7. The method of claim 1, wherein the transmission parameters comprise at least one of transmission power, transmission beam, or sounding reference signal for positioning (SRSp) configuration information.

8. The method of claim 1, further comprising:
determining to track the object along the tracking path from a plurality of tracking paths based at least in part on a downlink measurement or a DL-PRS resource.

9. The method of claim 1, further comprising:
determining that a plurality of tracking paths may be used to track the object; and
configuring the WTRU to track the object using at least one tracking path from the plurality of tracking paths.

10. The method of claim 1, further comprising:
transmitting a request to the wireless network for a different device within the wireless network to track the object along the tracking path.

11. A wireless transmit/receive unit (WTRU) comprising:
a processor; and
a transceiver, wherein the WTRU is configured to:
receive, from a wireless network, a first configuration information;
perform at least one sensing measurement based at least in part on the first configuration information;
detect an occurrence of an event;
send, based at least in part on detecting the occurrence of the event, a request to the wireless network for transmission parameters, wherein the transmission parameters are for tracking an object;
receive, from the wireless network, the transmission parameters based on the request; and
transmit reference signals based at least in part on the transmission parameters for tracking the object along a tracking path.

12. The WTRU of claim 11, wherein the first configuration information indicates at least one of: a downlink-positioning reference signal (DL-PRS) configuration, a reference DL-PRS identification (ID), or assistance information for tracking.

13. The WTRU of claim 12, wherein the assistance information for tracking comprises at least one of: a relative timing between a plurality of tracking paths, a tracking time window, a tracking region for the WTRU, a maximum tracking measurement value, a minimum tracking measurement value, or tracking object information.

14. The WTRU of claim 13, wherein the tracking object information comprises at least one of: a location of the object, a velocity of the object, a trajectory of the object, a radar cross section of the object, a classification type of the object, a material of the object, or a timestamp associated with object information.

15. The WTRU of claim 11, wherein the at least one sensing measurement is at least one of: reference signal received power (RSRP), reference signal received power per path (RSRPP), delay, relative delay, angle of arrival (AoA), Doppler shift, delay spread, Doppler spread, reference signal time difference (RSTD), WTRU receiving-transmission time difference, reference signal carrier phase (RSCP), or reference signal carrier phase difference (RSCPD).

16. The WTRU of claim 11, wherein the event comprises the at least one sensing measurement exceeding a threshold.

17. The WTRU of claim 11, wherein the transmission parameters comprise at least one of: transmission power, transmission beam, or sounding reference signal for positioning (SRSp) configuration information.

18. The WTRU of claim 11, wherein the WTRU is further configured to:
determine to track the object along the tracking path from a plurality of tracking paths based at least in part on a downlink measurement or a DL-PRS resource.

19. The WTRU of claim 11, wherein the WTRU is further configured to:
determine that a plurality of tracking paths may be used to track the object; and
configure the WTRU to track the object using at least one tracking path from the plurality of tracking paths.

20. The WTRU of claim 11, wherein the WTRU is further configured to:
transmit a request to the wireless network for a different device within the wireless network to track the object along the tracking path.
